(19) United States
(12) Patent Application Publication
(10) Pub. No.: US 2009/0303053 A1
(43) Pub. Date: Dec. 10, 2009

(54) Method and System for Controlling Termites

(75) Inventors: Theodore Alfred Evans, Australian Capital Territory (AU); Michael Lenz, Australian Capital Territory (AU); Joseph Cho Sam Lai, Australian Capital Territory (AU); Ra Ata Inta, Australian Capital Territory (AU)

Correspondence Address: NIXON & VANDERHYE, PC, 901 NORTH GLEBE ROAD, 11TH FLOOR, ARLINGTON, VA, 22203, US

(73) Assignees: Commonwealth Scientific and Industrial Research Organization, Campbell (AU); Newsouth Innovations PTY Ltd., Unsw Sydney New South Wales (AU)

(21) Appl. No.: 12/224,217

(22) PCT Filed: Feb. 26, 2007
(86) PCT No.: PCT/AU2007/000215

§ 371 Date: Jun. 22, 2009

Related U.S. Application Data
(60) Provisional application No. 60/776,842, filed on Feb. 24, 2006.

(30) Foreign Application Priority Data
Feb. 24, 2006 (AU) 2006200814

(51) Int. Cl. G08B 23/00

(52) U.S. Cl. 340/573.2

(57) ABSTRACT

A method of controlling pest termites. A vibrational signal which is perceptible to and behaviourally influential upon the pest termites is generated, and coupled into a medium for perception by the pest termites. Repellent termite alarm signals may be utilised. A new type of foraging signal is disclosed and may be applied to lure termites to a bait.

### CROSS-REFERENCE TO RELATED APPLICATIONS

The present application claims priority from Australian Provisional Patent Application No 2006200814, U.S. Provisional Patent Application No. 60/776,842 filed on 24 Feb. 2006, the contents of which are incorporated herein by reference.

### TECHNICAL FIELD

The present invention relates to pest control, and in particular relates to termite pest control by generation of vibrational signals.

### BACKGROUND OF THE INVENTION

Termites feed on cellulose in the form of living or dead plant tissue, such as timber, grass and man-made products like paper and cardboard. Termites live in colonies consisting of a primary pair (queen & king) assisted by a large number of workers, together with fewer soldiers which defend the colony from predators. Juveniles are also usually present. Certain weather conditions, usually storms, trigger mating flights in which male and female alates (winged termites) leave a parental nest to mate, disperse and establish new colonies.

Termite species are commonly classed as either “subterranean”, “drywood” or “dampwood” termites. Most pest species are subterranean termites, which need contact with the soil and moisture. Their nests may be visible as a mound, or may be concealed underground, in damp timber or in a tree. From the nest, workers make subterranean tunnels, sometimes more than 50 m long, to remote feeding sources. Where buildings are attacked there may be more than one entry point. Timbers vary in their susceptibility to attack, but those that are susceptible include both soft and hard woods. Infested timber is often hollowed out. Subterranean termites account for perhaps 95% of worldwide termite pest problems.

Damage to house frames may be expensive and need costly repairs, and in the worst cases the house or structure may be condemned and require demolition. In Australia alone, subterranean termites have been estimated to cost A$100 million/year in pest management, and a further A$680 million in repair of associated structural damage.

A range of termite pest control techniques exist. Preventive measures aimed at keeping termites away from a particular structure include physical barriers, chemical barriers, baiting systems and the use of termite-resistant building materials. For example, timber elements such as flooring, bearers, verandahs, pergolas and steps should be kept out of contact with the ground, and also should be kept out of contact with trees, shrubs and climbers. Termite nests in mature eucalyptus, tree stumps, hardwood sleeper walls and the like, being potential sources of building infestations, may be destroyed as a preventive measure. Where a building is on a concrete slab, ensuring that soil or timber is not piled against external walls is a further preventive measure. To prevent termite ingress for buildings on stumps or brick piers, “ant caps” are generally provided, such ant caps comprising a circular or square sheet of metal or the like placed atop the stump and extending laterally from the stump in all directions to prevent formation of termite tunnels from the ground to the house. Such ant caps should be checked regularly for breaches.

Where a building or structure is found to be infested by termites, remedial measures are required. Chemical treatment can be an effective remedial form of termite pest control, however an infestation can only be chemically treated by a licensed pest controller. Further, since the demise of organochloride insecticides in 1995 due to environmental concerns, chemical termite pest control has become more difficult. A pest controller will also usually attempt to locate and treat the source nest if possible.

Additional remedial measures include installing a chemical soil barrier or baiting system. Bait systems are useful for monitoring and treating infestations, but have had mixed success in termite pest control as termites do not find the bait stations quickly, and there is no known effective means for attracting termites to a bait station. Biological termite pest control agents such as parasitic fungi and nematodes have also been considered as potential remedial measures.

Societal interaction between termites has been investigated. For example, in a number of termite species it has been discovered that alarm signaling from soldier termites to other termites occurs when the soldier termites perceive a threat. Such alarm signaling is generated acoustically by the soldier termites drumming their heads against the substrate or shaking bodies held firmly to the substrate, in a manner which produces a train of pulses of substrate vibrations, with a carrier frequency dependent on the substrate (in some instances around 1 kHz) and a pulse repetition rate of tens of Hz. The worker termites of this species have several types of organs that sense vibrations at the base of the antennae and on the tibiae, and have the ability to sense, interpret, and respond to the pulse train of vibroacoustic alarm signals by retreating into the nest. Other soldier termites also respond to an alarm signal, by commencing to generate their own alarm signals by drumming their heads.

However in contrast to such societal interactions in response to a threat, a significant difficulty in termite pest control is that termite foraging behaviour is not generally well understood. A common perception is that termites are voracious and non-discriminating feeders, consuming all wood that they find. However, termites actually can be highly selective feeders. Wood species palatability and hardness are important, as are defensive chemicals made by the plant. Yet these are not the only criteria of assessment, and anecdotal accounts abound of termites, upon discovering a piece of apparently palatable wood, electing not to consume the wood. Clearly, the full mechanism of how termites assess a piece of wood as being suitable to eat is not well understood.

Further, noisy acoustic emissions are produced by the loud feeding of worker termites. Such acoustic emissions are a means by which the presence of termites may be detected, however remedial pest control must then be applied. The acoustic emissions are caused by wood fibres breaking, whether due to dryness, heat, stress, or termite feeding, and may be >20 kHz.

Any discussion of documents, acts, materials, devices, articles or the like which has been included in the present specification is solely for the purpose of providing a context for the present invention. It is not to be taken as an admission that any or all of these matters form part of the prior art base or were common general knowledge in the field relevant to the present invention as it existed before the priority date of each claim of this application.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### SUMMARY OF THE INVENTION

According to a first aspect the present invention provides a method of controlling pest termites, the method comprising:

generating a vibrational signal which is perceptible to and behaviourally influential upon the pest termites; and

coupling the vibrational signal into a medium for perception by the pest termites.

According to a second aspect the present invention provides a device for controlling pest termites, the device comprising:

a signal generator for generating a vibrational signal which is perceptible to and behaviourally influential upon the pest termites; and

a transducer for coupling the vibrational signal into a medium for perception by the pest termites.

Thus, the present invention recognises that it is possible to exploit termites' ability to perceive vibrational signals which in turn influence the termites' behaviour. By applying this recognition to pest control in particular, embodiments of the present invention may thus provide a valuable tool in preventive and/or remedial termite pest control.

The vibrational signal may be an alarm signal, a foraging signal, an acoustic emission signal, an artificially synthesised signal, or a combination of such signals, provided that it is behaviourally influential upon the pest termites. Where such signals differ between a first pest termite species and a second pest termite species, embodiments of the invention may be adapted to one particular pest termite species.

In preferred embodiments, the vibrational signal is a vibrational foraging signal. By producing a vibrational foraging signal, the present invention recognises that it is possible to influence termite pest behaviour by exploiting the native foraging behaviour of the pest termites in question. In preferred such embodiments of the invention, the vibrational foraging signal is attractive to the pest termites.

In embodiments where the vibrational signal is attractive to the pest termites, a termite controlling active substance may be provided.

Thus, according to a third aspect, the present invention provides a method of controlling pest termites, the method comprising:

generating a vibrational foraging signal which attracts the pest termites;

coupling the vibrational foraging signal into a medium for perception by the pest termites; and

exposing termites attracted to the vibrational foraging signal to a termite controlling active substance.

According to a fourth aspect the present invention provides a device for controlling pest termites, the device comprising:

a signal generator for generating a vibrational foraging signal which attracts the pest termites;

a transducer for coupling the vibrational foraging signal into a medium for perception by the pest termites; and

a termite controlling active substance to which termites attracted to the vibrational foraging signal are exposed.

In embodiments of the invention, the vibrational foraging signal is preferably recorded from the pest termite species in question, and played back through the signal generator. In further embodiments, the vibrational foraging signal may be a composition of multiple such recordings played simultaneously or sequentially, or an artificial synthesised signal, based on the natural signals.

Embodiments of the third and fourth aspects of the present invention may thus comprise the addition of the signal generator and the transducer to a known type of termite bait station. By producing the attractive vibrational signal, termites are enticed to enter the bait station, and the termites may thus find the bait station more rapidly than would otherwise have been the case.

Additionally or alternatively, the attractive vibrational signal may be used to lure termites into soil or wood treated with non-repellent insecticides. Additionally or alternatively, the attractive vibrational signal may be used to lure termites away from a particular structure or location for which protection is desired.

In alternative embodiments of the invention, the vibrational foraging signal may be of a type to repel the pest termites. For example, the vibrational foraging signal may be obtained from a second termite species different to the pest termite species, where such a signal serves to repel the pest termite species. For example, a foraging signal obtained from the second termite species may have the effect of causing the pest termites to forage elsewhere, thus having the effect of repelling the pest termites from the vicinity of the generated vibrational foraging signal.

In other embodiments of the first and second embodiments of the invention, the vibrational signal may comprise a vibrational alarm signal, for the purposes of repelling termites away from the vicinity of the signal source, or causing the pest termites to retreat into their nest. The vibrational alarm signal may be recorded from an actual alarm signal produced by the pest species desired to be controlled. Additionally or alternatively the vibrational alarm signal may comprise an artificially synthesised signal. For example the vibrational alarm signal may comprise a pulse train having a pulse repetition frequency in the range of 10 Hz-5 kHz, more preferably in the range of 10 Hz to 30 Hz. The pulse repetition frequency is preferably matched to a pulse repetition frequency of an alarm signal produced by head drumming of soldier termites of a pest species desired to be controlled. A carrier frequency of the pulse train is preferably matched to a carrier frequency of an alarm signal in the medium produced by head drumming of soldier termites of the pest species desired to be controlled. For example the carrier frequency of the pulse train of the vibrational alarm signal may be in the range of 1-3 kHz.

In some embodiments of the invention the signal generator may be a recording playback device, including a storage medium storing a recording of the vibrational signal. Alternatively the signal generator may comprise one or more oscillators having suitable oscillation characteristics to produce the vibrational signal. The one or more oscillators may be electrical or mechanical.

The transducer may comprise a shaker, whether an electromagnetic or electrodynamic exciter/shaker. Alternatively the transducer may comprise a piezoelectric element. The transducer may additionally or alternatively comprise a resonator which is resonant with the vibrational signal and adapted to couple to the medium.

The signal generator may be electrically connected to the transducer. Additionally or alternatively the signal generator may be wirelessly connected to the transducer. A plurality of transducers may be associated with a single signal generator, such that the signal generated by the signal generator is replicated by the plurality of transducers.

The medium into which the vibrational foraging signal is coupled may be soil, wood, air and/or a building structure.

In still further embodiments of the present invention, the vibrational signal may comprise a stressed cellulose vibrational signal. The stressed cellulose vibrational signal may be obtained by recording the foraging vibrations produced by termites eating cellulose, such as wood, while the cellulose is under tensile, compressive or torsional stress. Additionally or alternatively the stressed cellulose vibrational signal may comprise a synthesised vibrational signal adapted to mimic and reproduce the behavioural effects of such natural foraging vibrations. Such embodiments of the invention recognise that some species of termites are adept at consuming wood and the like only while the structural integrity of the wood remains adequate, and cease to consume the wood before structural failure.

Where the vibrational signal is repellent to the pest termites, such as being an alarm signal or a repelling vibrational foraging signal, such a repellent vibrational signal may be used to repel pest termites from a particular location for which protection is desired.

In preferred embodiments the vibrational signal has a dominant frequency greater than 1 kHz, more preferably greater than 2 kHz, and more preferably greater than 3 kHz. In preferred embodiments the vibrational signal has a dominant frequency less then 20 kHz, more preferably less than 15 kHz, and more preferably less than 10 kHz.

Some embodiments of the invention may utilise a vibrational signal adapted to a particular species of pest termite. In preferred such embodiments, where the species is Cryptotermes domesticus, the vibrational signal preferably has a dominant frequency of greater than 2.5 kHz, more preferably greater than 5 kHz, more preferably greater than 7 kHz, and more preferably substantially 7.2 kHz. In a particular embodiment the vibrational signal is preferably substantially the same as signal 4 shown in FIG. 3.

Embodiments of the present invention may generate the vibrational signal intermittently, for example at periodic intervals. Such embodiments of the present invention may further comprise detecting termite acoustic emission, and generating the vibrational signal upon detection of termite acoustic emission. A suitable acoustic emission detection system for use in such embodiments may be of the type set out in U.S. Pat. No. 6,883,375, U.S. Pat. No. 5,285,688, or the like.

### BRIEF DESCRIPTION OF THE DRAWINGS

An example of the invention will now be described with reference to the accompanying drawings, in which:

FIG. 1 is a schematic of all experimental treatments tested in Example 1;

FIG. 2 illustrates the dominant resonant frequency of P. radiata wooden blocks excited by C. domesticus termite workers;

FIGS. 3A and 3B illustrate time and spectral traces of playback signals in Example 1;

FIG. 4 illustrates the daily position of C. domesticus termite workers;

FIG. 5 illustrates the responses of C. domesticus workers to choice of wooden blocks with or without vibroacoustic signals;

FIG. 6 illustrates the proportional tunneling activity of C. domesticus termite workers;

FIG. 7 illustrates schematics of the food size experimental treatments in Example 2;

FIG. 8 is a schematic of the attractiveness of signal experimental treatments for Cryptotermes secundus;

FIG. 9 illustrates the signal attenuation across the T-maze;

FIG. 10 illustrates the daily position of the Cryptotermes secundus termites in the food size preference experiment;

FIG. 11 illustrates the tunneling activity of C. secundus termites;

FIGS. 12A and 12B illustrate time and spectral traces of playback signals in Example 2;

FIG. 13 illustrates the number of C. secundus termites that did not make a choice in the attraction experiment;

FIG. 14 illustrates the number of C. secundus termites that did make a decision in the attraction experiment;

FIG. 15 illustrates the time taken by C. secundus termites to make a decision in the attraction experiment;

FIG. 16 is a schematic of the attractiveness of signal experimental treatments for Coptotermes acinaciformis;

FIG. 17 illustrates the dominant resonant frequency of P. radiata wooden blocks excited by Coptotermes lacteus termite workers;

FIG. 18 illustrates the number of Coptotermes acinaciformis termites that did not make a choice in the attraction experiment of FIG. 16;

FIG. 19 illustrates the number of Coptotermes acinaciformis termites that did make a decision in the attraction experiment of FIG. 16;

FIGS. 20A to 20C illustrate the three treatments of the first experiment testing the repulsion effect of the Coptotermes acinaciformis alarm signal upon Coptotermes acinaciformis termites;

FIGS. 21A to 21C illustrate the three treatments of the second experiment testing the repulsion effect of the Coptotermes frenchi alarm signal upon Coptotermes acinaciformis termites;

FIG. 22 shows about 1.8 s of the time series of a single alarm signal event from an individual Coptotermes acinaciformis soldier after being band-pass filtered between 969 Hz and 2605 Hz to reduce noise;

FIGS. 23A and 23B are longer-time plots of the alarm signal event of FIG. 22, in the time domain and in the frequency domain, respectively;

FIGS. 24A and 24B are plots, in the time domain and in the frequency domain, respectively, of a single alarm signal event from an individual Coptotermes frenchi soldier after being band-pass filtered between 969 Hz and 2605 Hz to reduce noise;

FIG. 25 illustrates the wood consumption of Coptotermes acinaciformis termites in the experiment of FIG. 20;

FIG. 26 is a plot of the proportion of total amount of wood eaten from the block excited by the alarm signal, for each replicate of the treatment shown in FIG. 20C;

FIG. 27 illustrates the wood consumption of Coptotermes acinaciformis termites in the experiment of FIG. 21;

FIGS. 28A and 28B are plots of the dominant frequency of vibroacoustic foraging signals for a variety of wood sizes, produced by Coptotermes acinaciformis termites and by Coptotermes lacteus termites, respectively;

FIGS. 29A-29E are plots of the dominant frequency of vibroacoustic foraging signals for a variety of wood sizes, produced by Cryptotermes domesticus termites, Cryptotermes dudleyi termites, Cryptotermes primus termites, Cryptotermes queenslandis termites and by Cryptotermes secundus termites, respectively;

FIGS. 30A and 30B are plots of sample vibrational foraging signals produced by Coptotermes lacteus when feeding upon a variety of wood types, represented in the frequency domain and the time domain, respectively;

FIGS. 31A and 31B are plots of sample vibrational foraging signals produced by Mastotermes darwiniensis when feeding upon a variety of wood types, represented in the frequency domain and the time domain, respectively;

FIGS. 32A and 32B are plots of sample vibrational foraging signals produced by Nasititermes exitiosus when feeding upon a variety of wood types, represented in the frequency domain and the time domain, respectively;

FIGS. 33A and 33B are plots of sample vibrational foraging signals produced by Schedorhinotermes actuosus when feeding upon a variety of wood types, represented in the frequency domain and the time domain, respectively;

FIG. 34 is a plot of wave speed as a function of frequency, for each of Coptotermes', Schedorhinotermes', Nasutitermes', and Mastotermes' vibrational foraging signals;

FIG. 35 is a block diagram of a device for producing vibrational signals to influence the behaviour of termites in accordance with a first embodiment of the invention;

FIG. 36 is a schematic of a trench deployment of the device of FIG. 35;

FIG. 37 illustrates two bait station deployments of the device of FIG. 35;

FIG. 38 illustrates a first configuration for coupling the actuator of the device of FIG. 35 to a desired substrate;

FIG. 39 illustrates a second configuration for coupling the actuator of the device of FIG. 35 to a desired substrate;

FIG. 40 illustrates a third configuration for coupling the actuator of the device of FIG. 35 to a desired substrate;

FIG. 41 illustrates deployment of a plurality of devices of the type shown in FIG. 35 for the purpose of protecting a building structure.

### DESCRIPTION OF THE PREFERRED EMBODIMENTS

As used herein, the term “termite” or “termites” refers to any species of the Order Isoptera. Examples include, but are not limited to, Mastotermitidae, Termopsidae (Zootermopsis, Archotermopsis, Hodotermopsis, Porotermes and Stolotermes), Kalotermitidae (Kalotermes, Neotermes, Cryptotermes, Incisitermes and Glyptotermes), Hodotermitidae (Hodotermes, Microhodotermes and Anacanthotermes), Rhinotermitidae (Reticulitermes, Heterotermes, Coptotermes and Schedorhinotermes), Serritermitidae and Termitidae (Amitermes, Drepanotermes, Hospitalitermes, Trinervitermes, Macrotermes, Odontotermes, Microtermes, Nasutitermes, Pericapritermes and Anoplotermes). Further, specific examples of termites subject to control in the present Pacific territory include Reticulitermes speratus, Reticulitermes mivatakei, Reticulitermes flaviceps amamianus, Reticulitermes sp., Coptotermes formosanus, Coptotermes gestroi, Coptotermes guangzhoensis, Coptotermes vastator, Incisitermes minor, Cryptotermes domesticus, Cryptotermes brevis, Cryptotermes dudleyi, Odontotermes formosanus, Neotermes koshunensis, Glyptotermes satsumensis, Glyptotermes nakajimai, Glyptotermes fuscus, Glyptotermes kodamai, Glyptotermes kushimensis, Hodotermopsis japonica, Nasutitermes takasagoensis, Pericapriterme nitobei, Sinocapritermes mushae and the like. Reference to “pest termites” in the present specification is to be understood to include any termite species which forages upon wood which is in service. For example, termites which forage upon wooden buildings, wooden fences, wooden structures, or other wooden items made by humans, leading to economic loss, structural damage or cosmetic damage to wooden items of value. Such pest termites include species from subterranean, arboreal, dry and wet wood feeding ecologies. Examples of such pest Genera include, but are not limited to, Mastotermitidae; Cryptotermes, Incisitermes, Kalotermes, Neotermes, Coptotermes, Heterotermes, Psammotermes, Reticulitermes, Schedorhinotermes, Macrotermes, Microtermes, Odontotermes, and Nasutitermes.

Further, phrases such as “pest control”, “controlling pests”, “attracting”, “repelling” and the like used to describe embodiments of the present invention do not imply a need to produce complete control over the pest termites' behaviour. Instead such phrases are to be understood to include embodiments which produce a measurable alteration in behaviour of the pest termites arising from generation of the vibrational foraging signal. For example, a measurable alteration in behaviour may be assessed by determining a statistical significance of termite behaviour in response to the vibrational foraging signal.

Baits for use in the methods and devices of the invention comprise a termite controlling active substance and optionally one or more carriers.

Examples of a termite controlling active substance include, but are not limited to, carbamate compounds such as fenobucarb, xylylcarb, metolcarb, carbaryl, isoprocarb, propoxur and metoxadiazon; organophosphorus compounds such as chlorpyrifos, fenitrothion, malathion and phoxim; pyrethroid compounds such as tralomethrin, permethrin, cypermethrin, d-phenothrin, silafluofen, etofenprox, halfenprox, bifenthrin, acrinathrine, transfluthrin, cyphenothrin, fenvalerate, prallethrin and imiprothrin; arylpyrrole compounds or arylpyrazole compounds such as chlorfenapyr; nitroguanidine compounds or cyanoguanidine compounds such as acetamiprid, nitenpyram, thiamethoxam, thiacloprid and dinotefuran; macrolide compounds such as ivermectin, avermectin, emamectin, nemadectin and spinosad; insect growth regulators such as diflubenzuron, chlorfluazuron, hexaflumuron, noviflumuron, lufenuron, lufenuron, flufenoxuron, diafenthiuron, novaluron, fluazuron, teflubenzuron, triflumuron, cyromazine, dicyclanil, buprofezin, etoxazole, pyridaben, pyriproxyfen, tebufenozide, methoxyfenozide, halofenozide, fenoxycarb, diofenolan, methoprene and hydroprene; phenylpyrazole compounds; nepetalactone and the like as well as mixtures thereof.

The termite controlling active substance may be a biological control agent. Examples include, but are not limited to, fungi such as Beauveria sp. and Metarhizium sp., and infective stages of nematodes.

When utilizing a termite controlling active substance which also has a repellence directed to the termites, it is preferable that measures are taken to ensure that such repellent activity does not counter the attracting measures of the invention. For example, the termite controlling active substance can be microencapsulated using methods known in the art.

Chemical attractants can also be provided such as sitosterol and mimics thereof as described in US 20050031581, and (3Z,6Z,8E)-dodecatrienol.

Baits which are useful in the present invention can be in either liquid, gel, paste, solid or encapsulated form. If the termite controlling active substance is in a flowable form, such as liquid, gel or paste form, it can be absorbed onto, coated or otherwise impregnated into a suitable substrate using methods known to those skilled in the art. If the termite controlling active substance is a solid, it can be combined with a liquid carrier, such as in a solution, dispersion or emulsion. The liquid carrier can then be adsorbed, coated or impregnated onto a substrate. The liquid carrier can then be optionally evaporated leaving the solid toxicant behind as a coating on the substrate. Other methods of applying the termite controlling active substance to a substrate will be apparent to those skilled in the art.

A “carrier” can be any suitable material known to the skilled person such as cellulose.

Many baits are known to those skilled in the art and include pheromones, substances which possess food odors (including food materials), such as fats, oils, proteins, corn gluten, soy protein, carbohydrates, starches, sugars (e.g., dextrose, fructose, maltose, sucrose, and molasses, xylose), water and mixtures thereof.

Baits can be prepared by combining a mixture of a finely divided cellulose material, such as sawdust, with an amount of ingredient(s) sufficient to provide the desired result; for example, from about 0.01% to about 20% weight, preferably about 0.02 to about 5%, termite controlling active substance(s) and forming the mixture into a paste by the addition of about 1% to 5% of a water based binder such as agar.

In one embodiment, the bait is in the form of tablets. For example, in one suitable embodiment, the bait comprises at least one compressed tablet having a mass of between about 10 grams and about 45 grams, more preferably between about 25 grams and about 40 grams, and even more preferably about 35 grams.

In another embodiment, the termite controlling active substance is a delayed-action toxicant. More specifically, it is desirable that the target insect be treated with the termite controlling active substance in a bait station, but that the termite not be killed immediately by the termite controlling active substance. Thus, in an embodiment the termite controlling active substance does not kill the termite until it has had sufficient time to return to its nest or colony so that the termite controlling active substance can be transferred to other members of the target insect population. Delayed-action termite controlling active substances are known to those skilled in the art. However, delayed-action termite controlling active substances which are useful in the present invention include sulfluramid, diflubenzuron, chlorfluazuron, hexaflumuron, noviflumuron and avermectins. A suitable delayed-action termite controlling active substance useful in the present invention is the perfluorinated insecticide disclosed in U.S. Pat. No. 4,929,696.

Typically, the bait will be provided in a suitable “bait station” to aggregate termites to a few points close to the outside or inside of the structure and application of termite controlling active substance either to a food matrix in the stations or directly to the termites. In at least some embodiments, termites carry the termite controlling active substance back to the nest where it is passed along to nest-mates via mutual food exchange or grooming. Examples of bait stations which may be adapted for use with the devices and methods of the invention include those described in U.S. Pat. No. 5,329,726, U.S. Pat. No. 6,016,625, US 20010025447, US 20020134003, US 20040237380, US 20040065001 and US 20040200134.

The device(s) for signal generation and/or playback of the vibrational signals for attracting or repelling the pest termites may be constructed in one of a number of ways, as will be appreciated by a person of skill in the field of vibrational signal generation. For example, the device may comprise a storage medium containing the appropriate signal. The appropriate signal could be a recorded termite foraging signal, a recorded termite alarm signal, a recorded acoustic emission signal, an artificially synthesised signal or a combination of such signals that influence the behaviour of the pest termites. The medium can take the form of any electronic storage medium such as a CD, a compact flash card, a memory stick, a flash drive, and/or a hard-disk drive.

The device may further comprise a signal generator with a signal conditioner and/or amplifier for playing the signal contained in the storage medium. This can take the form of a CD player, an MP3 player which is capable of playing the storage medium specified in 1 above, or other playback device. The frequency range of the playback device should be from DC to 10 kHz and preferably to 20 kHz. Further, the device may comprise a transducer for coupling the signal received either vibrationally or acoustically into a medium for perception by the pest termites. The transducer can take the form of an electromagnetic/electrodynamic exciter/shaker or a piezoelectric element (such as PVDF film) or a piezoceramic element or loudspeaker. The frequency range of the transducer should be from DC to 10 kHz and preferably to 20 kHz. For vibrational coupling to the medium (such as substrate or timber structures), the transducer can be attached using mechanical fasteners (such as bolts, screws, nails or pins) or adhesives. A connector for transmitting the signal from the signal generator to the transducer could be physical or wireless (based on bluetooth or WiFi technologies such as 802.11b, 802.11g).

All the elements in the device could be constructed housed within a single integrated unit. In the case of wireless transmission of signals, it is envisaged that the signal generator will be constructed as a base station for transmitting the appropriate signal to a number of transducers which will be equipped with receivers. Such transducers could then be physically distributed as appropriate for pest control, for example around the perimeter of an area to be protected, to receive the wireless signals from the base station and output corresponding vibrations.

An example of a physical device that has been demonstrated to have influence on the behaviour of the Drywood Cryptotermes domesticus workers is described as follows. The vibration signals produced by groups of Cryptotermes domesticus workers in blocks of pine wood of various lengths (20, 40, 80 and 160 mm long) were recorded using a Bruel & Kjaer (B&K) (Naerum, Denmark) 4370 accelerometer and a B&K 2635 charge amplifier via the sound card of a personal computer. The signals were converted into audio files stored on a CD. The CD was played using a Sony (Tokyo) portable CD player DEJ100S/L. The signal from the headphone jack of the CD player was fed into a Philip Harris (Leicestershire, England) C5H30701 vibration shaker. The shaker was connected to the pine wood using screws. The amplitude of the signal was adjusted by the volume control of the CD player.

### Examples

### Example 1

### Cryptotermes Domesticus

### Example 1

### Materials and Methods

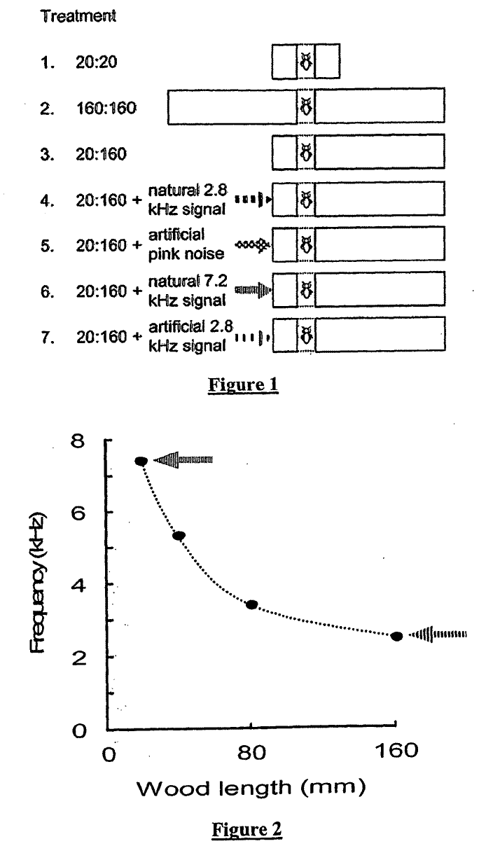

Food Size Preferences. We tested the possibility that termites had food size preferences and that they could detect food sizes without directly measuring the size of the food in bioassays using pairs of wooden blocks. Seasoned, air-dried Pinus radiata wood, with a cross-sectional area of 20×20 mm was used. Pairs of blocks were cut sequentially so that the blocks in each pair would be as similar to each other as possible. There were two possible block lengths, 20 mm or 160 mm. FIG. 1 is a schematic of all experimental treatments. Treatment indicates the length of the two blocks (in mm) and the playback signal (if any). The termite symbol represents the 15 worker termites in the central cell.

First, the possibility that termites could be using vibroacoustic signals to assess wood size was investigated. That is, it was investigated whether worker termites are able to detect vibration/acoustic signals generated by their foraging and use these signals to determine food quantity. For this purpose, the wooden blocks were arranged in three treatments, shown in FIG. 1: treatment 1, 20 mm and 20 mm (n=16 replicates); treatment 2, 160 mm and 160 mm (n=16 replicates); and treatment 3, 20 mm and 160 mm (n=44 replicates).

The blocks were separated by 10 mm, with the just-cut surfaces facing one another, and held together with aluminum foil and tape on three sides and glass on the top, thus creating a central cell (FIG. 1). Groups of 15 worker termites were placed into these cells, thus exposing them to almost identical 20×20 mm surfaces, but the termites were prevented from having any other contact with the wooden blocks. Groups of worker Cryptotermes domesticus termites from colonies in laboratory culture that had been collected from northern Australia were sealed in the central cell. The blocks were kept at 35° C. and 90% relative humidity and covered with black plastic. Each day for the first 5 days the position of the termites was recorded. After this period the termites were left undisturbed under the black plastic and allowed to tunnel into the wood for another 9 days (i.e., 2 weeks in total).

Measuring Signals. Recordings were made of the vibration signals produced by groups of Cryptotermes domesticus workers in blocks of pine wood that were 20 mm, 40 mm, 80 mm, and 160 mm long. A 5-mm-deep hole was drilled into the top of each block, into which groups of 15 termites were placed. A glass slide placed over the top of the hole contained the termites. A Brüel & Kjaer (Naerum, Denmark) 4370 accelerometer (charge sensitivity of 10.121 pC/ms⁻²) was attached to the base of the wooden block under test, and this was connected to a Brüel & Kjaer 2635 charge amplifier and a Tektronix differential amplifier (AM 502). The experiment was performed in an anechoic room, and the signal was monitored by using an Ono Sokki (Yokohama, Japan) fast Fourier transform CF 350 analyser and recorded on a personal computer for analysis with the MATLAB signal processing toolbox (MathWorks, Natick, Mass.).

FIG. 2 illustrates the dominant resonant frequency of P. radiata wooden blocks excited by C. domesticus termite workers. The arrows indicate signals used in playback experiments, and the shading of the arrows matches that shown in FIG. 1. FIG. 2 shows that the dominant frequency recorded from the wooden blocks varies inversely with block length, so that the dominant frequency decreases as block size increases.

Signals and Food Preferences. As discussed in more detail below, results from the food size preferences experiment indicated that C. domesticus workers preferentially chose to tunnel into the 20-mm block. To determine whether the termites used vibration signals to measure wooden block size, the influence of two of the recorded natural signals and two artificially synthesized signals on the decision-making of workers choosing wooden blocks was examined, by way of treatments 4 to 7 shown in FIG. 1. In treatments 4 to 7, groups of 15 C. domesticus workers were sealed between two sequentially cut blocks of pine wood, one of 20 mm and the other of 160 mm (as for treatment 3 above). In treatment 4, a signal having a dominant frequency of 2.8-kHz recorded from the C. domesticus workers in the 160-mm blocks (“natural 2.8 kHz signal”) was played or coupled into the 20-mm block (n=40 replicates). In treatment 5, a pink noise signal (i.e., static noise in which energy across each frequency band or octave is the same) was played into the 20-mm block (n=32 replicates). In treatment 6, a signal having a dominant frequency of 7.2-kHz recorded from the C. domesticus workers in the 20-mm blocks (“natural 7.2 kHz signal”) was played into the 20-mm block (n=8 replicates). In treatment 7, an artificially generated 2.8-kHz signal equivalent to the dominant frequency recorded in the 160-mm blocks was played into the 20-mm block (n=8 replicates).

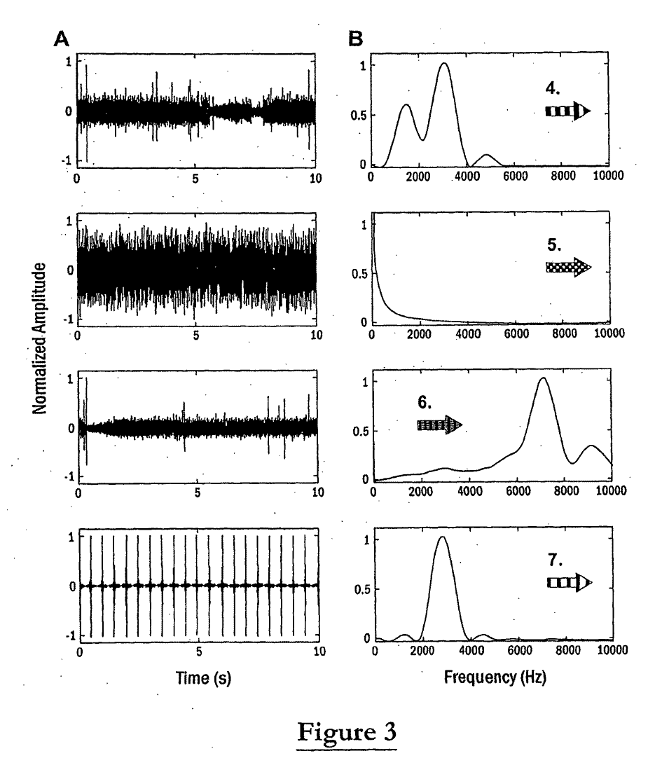

The natural 2.8-kHz signal was recorded from termites in a 160-mm block; the natural 7.2-kHz signal was recorded from termites in a 20-mm block; the artificial pink noise was energy-modulated static noise generated by a computer; the artificial 2.8-kHz signal was generated by using a computer. The time traces of the natural 2.8 kHz signal, the natural 7.2 kHz signal and the two artificial signals synthesized on computer are illustrated in FIG. 3A. The corresponding frequency spectra obtained by applying the fast Fourier transform to the time traces are displayed in FIG. 3B for each respective signal, with the dominant frequency in the natural signals being evident. The shaded arrows in FIG. 3 indicate the signals used in playback experiments, with the shading type of each arrow matching that shown in FIG. 1.

For treatments 4 to 7, block pairs were all assembled as described above for treatment 3, with the just-cut, almost identical, surfaces facing into the cell. However, treatments 4-7 were not assembled with glass and aluminum foil, because these materials might have transmitted some signal. Instead, the playback treatments 4-7 were assembled with a 20-mm tube of thin plastic sheet. This was roughened on the base to allow for easier walking by the termites. The 20-mm wooden block was attached with a screw to a Philip Harris (Leicestershire, United Kingdom) shaker, which received the signal from a Sony (Tokyo) Discman. As for treatments 1-3, for treatments 4-7 the position of the termites was noted for the first 5 days, and after 2 weeks the experiment was stopped, the numbers of termites and holes were counted, and the depth of the tunneling into the wooden blocks was measured.

Preferences between blocks in a pair were tested by using paired t tests, and differences between treatments were tested with the proportion of total tunneling activity that occurred in the 20-mm block by using ANOVA. Tunnel-length data were log-transformed to improve normality and homogeneity of variance assumptions.

### Example 1

### Results and Discussion

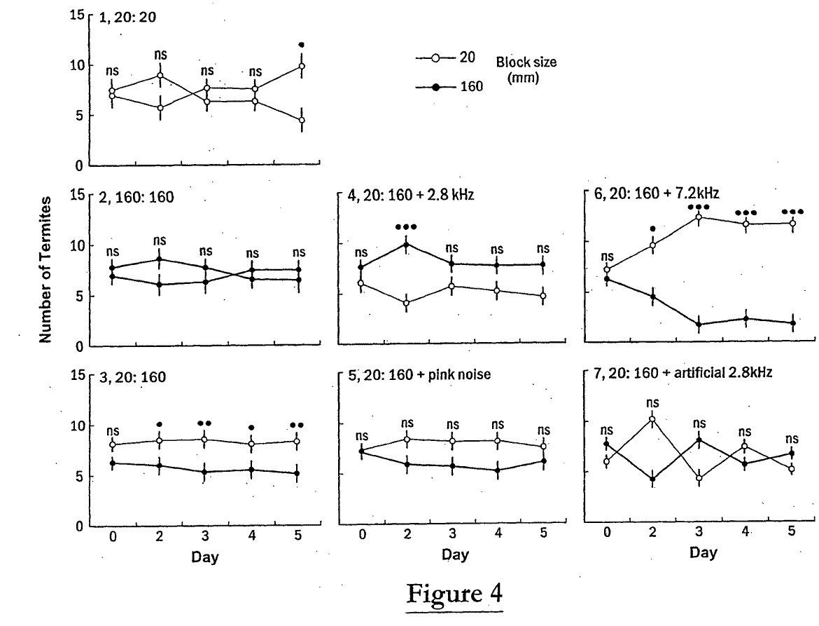

Food Size Preferences. The termites had no preference when presented with two almost identical pieces of wood. FIG. 4 illustrates the daily position of C. domesticus termite workers in the first 5 days of the experiments, with each plot corresponding to a single treatment, as indicated. Shown is the average (±standard error) number of workers in either block. Open circles and dotted line represent 20-mm blocks, while filled circles and solid line represent 160-mm blocks. Levels of significance are indicated on FIG. 4, with ns indicating a result is not significant, * indicating P<0.05, ** indicating P<0.01, and *** indicating P<0.001.

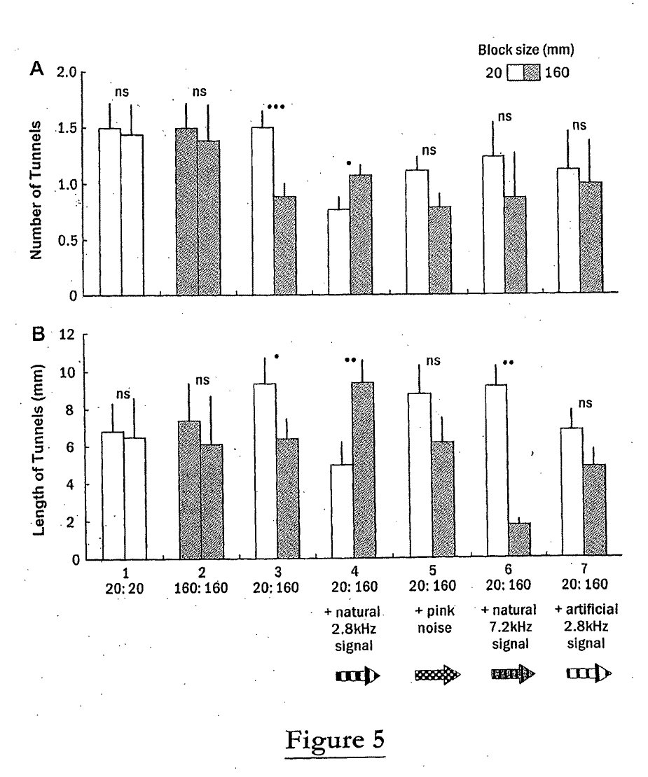

As can be seen in FIG. 4, similar numbers of termites were observed on both inner surfaces in treatment 1 (20:20) and treatment 2 (160:160) during the first 5 days of observation. After 2 weeks, the termites had produced a similar number of tunnels in each block (for treatment 1 t value with 15 df (t₁₅)=0.169, P=0.868; for treatment 2 t₁₅=0.355, P=0.728). Further, these tunnels were of similar length (for treatment 1 t₁₅=0.554, P=0.587; for treatment 2 t₁₅=0.684, P=0.505). FIG. 5 illustrates the responses of C. domesticus workers to choice of wooden blocks with or without vibroacoustic signals, with each pair of columns corresponding to a single treatment, as indicated. FIG. 5A illustrates the number of tunnels (average±standard error) in paired wooden blocks, while FIG. 5B illustrates the total length of tunnels (average±standard error) in paired wooden blocks at the end of the experiment. Open columns correspond to the 20-mm blocks, while filled columns correspond to the 160-mm blocks. Levels of significance are indicated on FIG. 5, with ns indicating a result is not significant, * indicating P<0.05, ** indicating P<0.01, and *** indicating P<0.001.

In stark contrast to treatments 1 and 2, termites showed a clear preference for the 20-mm block of wood in treatment 3 (20:160). More workers were observed sitting on the 20-mm surface in the first 5 days (see FIG. 4), and after 2 weeks the termites had chewed significantly more tunnels (t₄₃=4.687, P<0.001) and significantly deeper tunnels (t₄₃=2.189, P=0.034) in the 20-mm block (see FIG. 5).

Signals and Food Preferences. Observation of the position of the termites on the inner surfaces during the first five days of the experiment showed that the termites had a clear preference for the 160-mm block when the 20-mm block was excited by the 2.8-kHz signal, a preference for the 20-mm block when it was excited by the pink noise signal, a much greater preference for the 20-mm block when it was excited by the 7.2-kHz signal, and no preference for either block when the 20-mm block was excited by the 2.8-kHz artificial signal (FIG. 4).

These behavioural observations were confirmed by the tunneling patterns recorded at the end of the experiment. Both the number of tunnels and the total length of tunnels, shown in FIGS. 5A and B, respectively, were higher in the 160-mm block in treatment 4: number of tunnels, t₃₁=2.252, P=0.032; tunnel length, t₃₁=2.926, P=0.006. The tunneling differences were not significant in treatment 5, although it is worth noting the tunneling activity, number of tunnels, t₃₁=1.775, P=0.086; tunnel length, t₃₁=1.623, P=0.115. Tunneling activity was significantly higher in the 20-mm block for treatment 6: number of tunnels, t₇=2.049, P=0.080; tunnel length, t₇=3.565, P=0.009. Finally, tunneling activity did not differ significantly in treatment 7: number of tunnels, t₇=0.243, P=0.815; tunnel length, t₇=0.427, P=0.682.

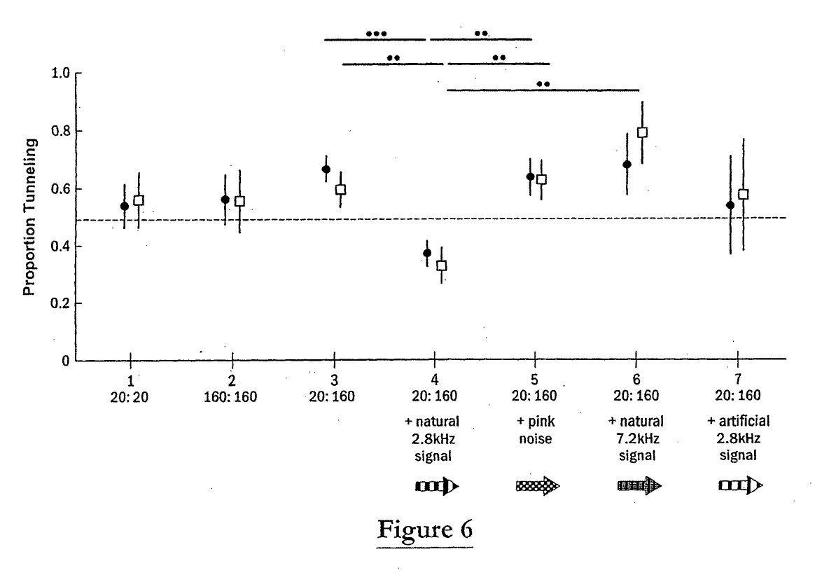

The lack of significant difference in tunneling activity in treatment 5 suggested that random noise had the effect of changing the termite tunneling behaviour, directing it away from the 20-mm block. However, an examination of the data in FIGS. 4 and 5 shows that treatments 3, 5, and 6 have the same pattern of higher tunneling in the 20-mm block. This pattern is supported by comparing the proportions of tunneling in the 20-mm block. FIG. 6 illustrates the proportional tunneling activity of C. domesticus termite workers in the 20-mm blocks at the end of the experiments. Filled circles correspond to the average (±standard error) proportion of tunnels, while open squares correspond to the average total tunnel length in the 20-mm block. For treatments 1 and 2, one block in each pair was chosen randomly to calculate proportion of tunneling activity for comparison with other treatments. The dotted line indicates 50% (i.e., no preference). The shaded arrows once again indicate the signals used in the playback experiments of treatments 4-7, with the shading of the arrows matching that shown in FIGS. 1, 3 and 5. Levels of significance are indicated on FIG. 6, with * indicating P<0.05, ** indicating P<0.01, and *** indicating P<0.001.

As can be seen in FIG. 6 the proportion of the total number of tunnels differed significantly among treatments (F_{6,149}=4.336, P<0.001). This result was driven by the difference between treatment 4 and treatments 3 (Bonferroni-corrected P<0.001) and 5 (P=0.003), as all other paired comparisons were not significantly different (although the comparison of treatments 4 and 6 was nearly so). The proportion of tunnel length in the 20-mm block differed significantly among treatments also (F_{6,149}=3.446, P=0.003). As for the proportion of tunnel numbers shown above, this result was driven by the difference between treatment 4 and treatments 3 (Bonferroni-corrected P=0.014), 5 (P=0.010), and 6 (P=0.017), respectively. All other paired comparisons were not significantly different.

These results were not a consequence of termite survival, because the number of survivors did not differ significantly between treatments (F_{6,149}=1.625, P=0.144). However, the number of secondary, neotenic reproductives did differ significantly between treatments (F_{6,149}=9.826, P<0.001). The patterns of significant difference were complex, but the most consistent differences were between treatments 4 and 6 and the remainder. Therefore, treatments were grouped into those that did not have any playback (1, 2, and 3), with an average of 4.0±0.2 neotenics, those that had natural recorded signals (4 and 6), with an average of 1.8±0.2 neotenics, and those that had artificially generated signals (5 and 7), with an average of 3.6±0.3 neotenics. The number of survivors did not differ significantly among these grouped treatments (F_{2,153}=1.149, P=0.320), but the number of secondary, neotenic reproductives did (F_{2,153}=20.883, P<0.001). This latter difference was caused by the natural-signal grouped treatments having significantly fewer neotenics than the other two grouped treatments (Bonferroni-corrected post hoc comparisons, P<0.001) and by there being no difference between the other two (P=0.864).

Thus, it can be seen that termites did not show any preference, either in sitting behaviour or tunneling, between almost identical blocks in treatments 1 and 2. They did show a clear preference for the smaller block in treatment 3, and it appears that the only source of information available by which to differentiate between these surfaces were vibroacoustic signals that they generated, which were affected by the size of the block of wood.

The present invention thus recognises that one possible parameter of concern to the termite in assessing a food source is the quantity of food. Different termite species that live in the same habitat feed on particular sizes of wood, some species targeting smaller fallen twigs and sticks and others targeting large fallen branches or entire trees. Whether this is done to avoid competition or otherwise, the question has remained as to how termites measure the size of a piece of wood. Termites come into contact with a small part of any one piece of wood and decide to eat it based on this minor contact. The decision to eat a piece of wood is made by the termites before the piece of wood is measured directly. They do not pace linear dimensions, which would expose them to predators. Nor can they evaluate their food visually, because the worker termites are blind.

As would be expected, the resonant frequency of a wooden block decreased with increasing block size (FIG. 2). When recorded signals from large or small blocks were played into the small block, the termites changed their behaviour. In particular, when the signal from the large block was played, the preference either disappeared or was reversed (treatment 4), and when the signal from the small block was played, the preference was maintained and the response was increased (treatment 6). Termites did not change their behaviour when a random pink noise signal was played into the small block (treatment 5), but their preference disappeared when an artificially generated signal of the dominant frequency of the large block was played into the small block (treatment 7).

These results indicate that the termites were using the vibrational response of the blocks to determine the block size. However, the dominant frequency does not appear to be the only information that the termites perceived, as indicated by comparing the results from the natural 2.8 kHz and artificial 2.8 kHz large-block signals (treatments 4 and 7). In treatment 7, the termites that were played the artificial 2.8 kHz signal via the 20 mm block showed no preference for either block (160 or 20 mm with the signal), indicating that the termites perceived both blocks to be the same. In treatment 4, the termites that were played the natural 2.8 kHz signal via the 20 mm block showed either no preference or a preference for the large 160 mm block (depending on the measurement), indicating that the termites perceived the blocks differently. Thus, by comparing treatments 4 and 7 to treatment 3, it can be seen that such vibrational signals coupled into the 20 mm block of wood were perceptible to the termites, and influenced the behaviour of the termites. That is, the termites showed differences in their response to vibration recordings of termites compared with artificially generated signals having the same dominant frequency, suggesting that the termites can discriminate the source of vibration.

A further indication of the influence of playing back such vibrational signals can be seen by comparing the results from treatment 3 (no signal) and treatment 6 (natural 7.2 kHz signal), notably the results of FIG. 4. The termites showed the same pattern of response, namely, preferring the small block. However, the magnitude differed, because termites showed a greater preference for the small block with the natural signal (treatment 6). The influence of vibration signals in the termites' decision making can also be seen from the decrease in the variability of the response when a signal was played (treatment 6). The variance in the number of tunnels in the 20- and 160-mm blocks was higher in the no-signal group (treatments 1-3), 0.68 and 0.79, respectively, compared with that in the natural-signal group (treatments 4 and 6), 0.46 and 0.41, respectively, and in the artificial-signal group (treatments 5 and 7), 0.52 and 0.61, respectively.

These results indicate that C. domesticus termites prefer the smaller 20 mm food resource over the larger 160 mm food source. Further, the results indicate that this preference is put into practice by a vibroacoustic assessment, such vibroacoustic signals not having been previously identified. Thus, the present invention exploits the recognition that certain vibration signals can influence the decision-making process of food selection by termites.

### Example 2

### Cryptotermes Secundus

The preceding example illustrates that C. domesticus preferentially chooses smaller (20 mm) food over larger (160 mm) food. Common sense suggests that the termites ought to have chosen the larger piece of food to maximise food supply. Thus further questions arise from this result, such as whether other termite species display this behaviour, and what is the advantage of this behaviour. To explore these issues a comparative assessment of another species in the genus has been carried out.

Cryptotermes is a large and widespread genus of drywood termites and its species share the same basic life history. Drywood termites live entirely within their wooden food, which they leave only as alates to search for new food sources in which to start a new colony. The differences between congeneric species are primarily in distribution. Some species have become widespread, cosmopolitan even, carried around the world by human activity, and are economic pests, including C. domesticus, whereas other drywood species are restricted to small and localized areas in native tree species, and are not considered as pests.

Distribution appears to be related to behaviour. It has been found that a range of Cryptotermes species, pest and non-pest, had different responses to food volumes. The workers of pest species, including C. domesticus, responded to being separated from their colonies, with many workers maturing into neotenic secondary reproductives rapidly, which then fought for reproductive dominance until only a single pair remained alive, and did so in smaller volumes of wood. In comparison, localized species responded slowly, often with few or only two individuals maturing into neotenic secondary reproductives, with little if any aggression. The vibration/acoustic signal identified above in C. domesticus may be implicated, as fewer individuals matured into neotenic secondary reproductives when this signal was played.

Therefore, a comparison of the vibration signals and foraging choices of C. domesticus as a pest species, to those of a restricted range species, may provide insight into species differences. One of the most geographically restricted drywood species is C. secundus, which is found only in mangrove areas of tropical northern Australia. Despite being common in the mangroves around the harbour of the city of Darwin, C. secundus has not been recorded as a pest in Darwin houses, and for these reasons was selected as a counter example to C. domesticus.

### Example 2

### Methods

Food size preferences. C. secundus was tested to determine whether the termites could detect food sizes using vibrations, and to establish any food size preferences. The methodology used previously for C. domesticus was again followed, but with additional treatments. FIG. 7 illustrates schematics of the food size experimental treatments. Each treatment indicates the length of the two blocks (20 mm or 160 mm) and the playback signal (if any). Also indicated is the playback signal applied, if any, by the following symbols: 160→=natural 160 mm signal; 20→=natural 20 mm signal; ≈160→=artificial 160 mm signal; ≈20→=artificial 20 mm signal; and P→=pink noise signal. Shading shows which block is excited by the signal. The termite represents the 15 worker termites in the central cell. Food size preferences were tested using pine wooden blocks with cross sectional area of 20 mm×20 mm. Pairs of blocks were cut sequentially so that each block in a pair would be as similar as possible. There were two lengths: 20 mm or 160 mm, which were arranged in the following treatments, with the number of replicates indicated in parentheses:
1. 20 mm and 20 mm (12);
2. 160 mm and 160 mm (12);
3. 20 mm and 160 mm (12);
4. 20 mm receiving the ‘natural 160 mm signal’ recorded from termites on a 160 mm block (dominant frequency of 3.5 kHz) and 160 mm without signal (24);
5. 20 mm without signal and 160 mm receiving the ‘natural 160 mm signal’ (12);
6. 20 mm receiving the ‘natural 20 mm signal’ recorded from termites on a 20 mm block (dominant frequency of 5.9 kHz) and 160 mm without signal (24);
7. 20 mm without signal and 160 mm receiving the ‘natural 20 mm signal’ (12);
8. 20 mm receiving a pink noise (i.e. static noise where energy across each frequency band is the same) signal and 160 mm without signal (12);
9. 20 mm without signal and 160 mm receiving a pink noise signal (12);
10. 20 mm receiving an ‘artificial 160 mm signal’ generated by computer (dominant frequency of 3.5 kHz) and 160 mm without signal (24);
11. 20 mm without signal and 160 mm receiving the ‘artificial 160 mm signal’ (12);
12. 20 mm receiving an ‘artificial 20 mm signal’ generated by computer (dominant frequency of 5.9 kHz) and 160 mm without signal (12); and
13. 20 mm without signal and 160 mm receiving the ‘artificial 20 mm signal’ (12).

The blocks were assembled as previously described in Example 1 for C. domesticus. The blocks in treatments 1, 2 and 3, having no signal playback, were separated by about 15 mm, with the just-cut surfaces facing one another, held together using aluminum foil and tape on three sides, and glass on the top, thus creating a central cell as shown in FIG. 7. The blocks in all treatments 4 to 13, i.e. those involving signal playback, were separated as above, but held together with a 15 mm tube of thin plastic sheet, roughened on the base to allow for easier walking by the termites. Soft plastic was used in treatments 4 to 13 to minimize any transmission of signal. The blocks in the playback treatments were attached with a screw to a Philip Harris shaker, which received the signal from a Sony Discman, as appropriate to the treatment. In all treatments foam was used to provide vibrational isolation between the paired blocks and the trays on which they were placed.

A group of 15 worker termites was placed into the central cell in each treatment, so that they were exposed to almost identical 20 mm×20 mm surfaces, but were prevented from having any other contact with the wood blocks. The termites were from colonies collected from mangroves in Darwin Harbour (12°31′ south, 130°55′ east) in northern Australia. The blocks were kept in the dark at 28° C. and 90% relative humidity for 14 days. Each day for the first five days the position of the termites was recorded. After this period the termites were left undisturbed in the dark and allowed to tunnel into the wood for another nine days. Because these experiments did not run simultaneously, those replicates run later could have had higher mortality, and were excluded from the analysis. Preferences between blocks in a pair were tested using 95% confidence intervals.

Of the replicates used in the analysis, the termite survival was high (average±standard error, 89.3±1.0%), and did not differ significantly between treatments (F_{12,146}=1.124, p=0.345). Few termites matured into neotenic, secondary reproductives in this experiment, typically one or two in any replicate (1.4±0.1), and so were not considered further.

Measuring signals. Recordings were made of the vibration signals produced by groups of C. secundus workers on blocks of Pinus radiata wood that were 20 and 160 mm long, respectively. A five millimeter deep hole was drilled into the top of each block, into which groups of 15 termites were placed; a glass slide placed over the top of the hole contained the termites inside. A Brüel & Kjaer (B&K) 4370 accelerometer (charge sensitivity 10.121 pC/ms⁻²) was attached to the base of the wooden block under test, and this was connected to a Brüel & Kjaer 2635 charge amplifier. The experiment was performed in an anechoic room, and the signal was monitored using an Ono Sokki Fast Fourier Transform (FFT) analyser CF 350 and recorded on a PC for analysis using MATLAB signal processing toolbox.

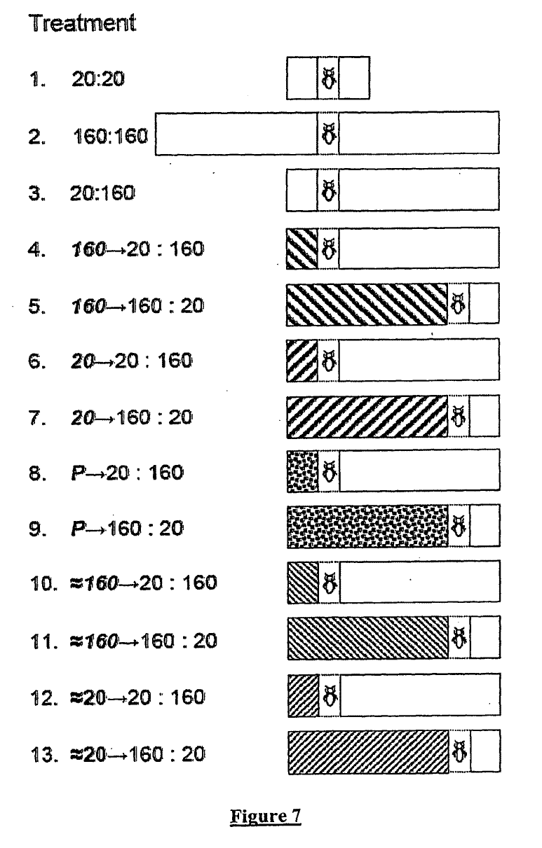

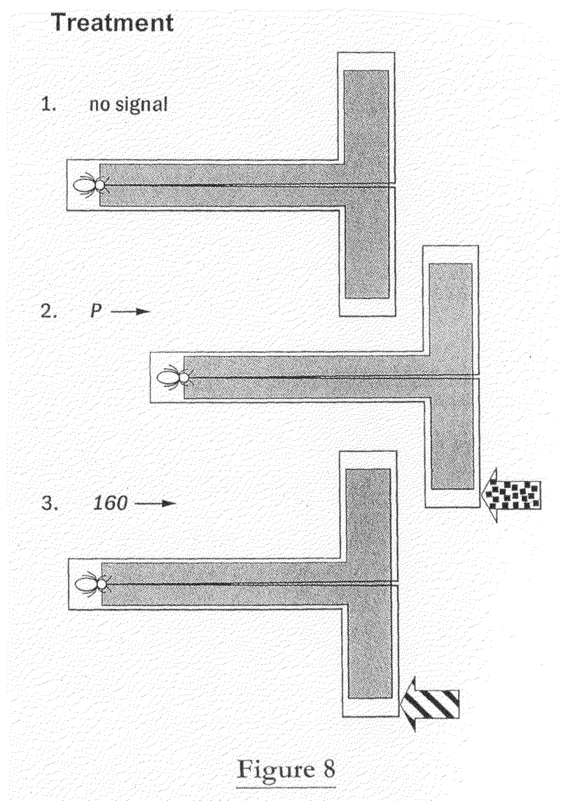

Attractiveness of signal. The potential attractiveness of signals was examined to determine whether the natural vibration signals did indeed have an attractive effect. FIG. 8 is a schematic of the attractiveness of signal experimental treatments. Cardboard T mazes were cut as shown. The termite represents a single worker termite placed at the proximal end of the T-maze, while the shaded arrows represent a signal played at one of the two distal ends of the T-maze. The light grey shaded T shape indicates the transparent plastic T shaped cover over the maze. The symbol P→ indicates that pink noise is played at the distal end of the second T-maze, while the symbol 160→ indicates that playback of a natural 2.8 kHz signal occurs at the distal end of the third T-maze.

The cardboard T-mazes of FIG. 8 were 120 mm long and 120 mm wide; the breadth of the cardboard was 20 mm. The two distal ends were gripped by bulldog clips that were attached to Philip Harris shakers, which were plugged into Sony Discmans. The T-maze was cut along the mid line, from the distal end to 15 mm short of the proximal end, and the two distal ends were pulled about 0.5 mm apart, to reduce signal transmission from one side of the T-maze to the other.

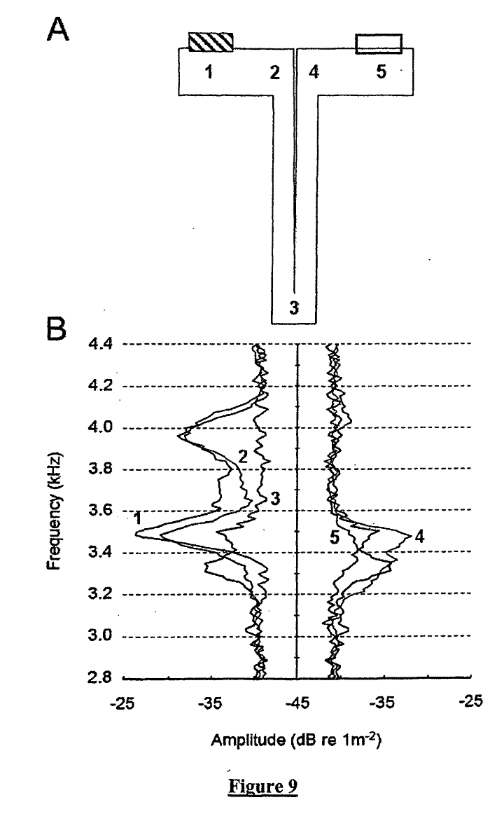

FIG. 9 illustrates the signal attenuation across the T-maze. In FIG. 9A, the positions on the T-maze used for recording are indicated, in that Position 1=signal source at distal end, Position 3=proximal end where termite was placed, and Position 5=distal end without signal. The hatched rectangle at Position 1 indicates the bulldog clip holding the distal end that is connected to the shaker playing the natural 160 mm signal (with corresponding shading type used in FIGS. 7 and 8). FIG. 9B is a plot of the fast Fourier transform frequency (FFT) of the acceleration (acceleration spectra) measured at the five positions along the T-maze. The same volume level on the Sony Walkman was used for these T-maze recordings as in both experiments. The numbered spectra correspond with the numbered recording positions, with the signal side and non-signal sides separated according to FIG. 9A. The acceleration spectrum for Position 3, the proximal starting position for the test termites, is duplicated on both sides of the graph of FIG. 9B.

FIG. 9B illustrates that the vibration signal was present primarily on the playback side of the maze, and decreased with distance from the source. There were three treatments: 1, there was no signal from either Discman; 2, the pink noise static signal was played from one Discman; and 3, the natural 160 mm signal was played from one Discman. For treatments 2 and 3, the signal was played an equal number of times from left and right Discmans.

A single termite was placed at the proximal end of the T-maze and a transparent plastic T shaped cover (about 5 mm smaller in all dimensions than the cardboard T) was placed on the T. This cover reduced the air movement disliked by termites, and helped prevent the termite from walking under the T-maze. A termite was determined to have made a choice when it had walked up the T, turned left or right and walked 30 mm towards a bulldog clip, within two minutes. This time was chosen as it was ten times the period a worker termite could walk the length of the maze (12 seconds). If a termite had not made a choice in two minutes, it was discarded and a new test begun. Tests were run until 20 termites in six colonies had chosen for each treatment. No T-maze was used twice, to avoid confounding effects of any potential trail-following pheromone. The number of discards, the number of each signal choice, and the time taken to choose were tested using ANOVA and paired t-tests.

### Example 2

### Results

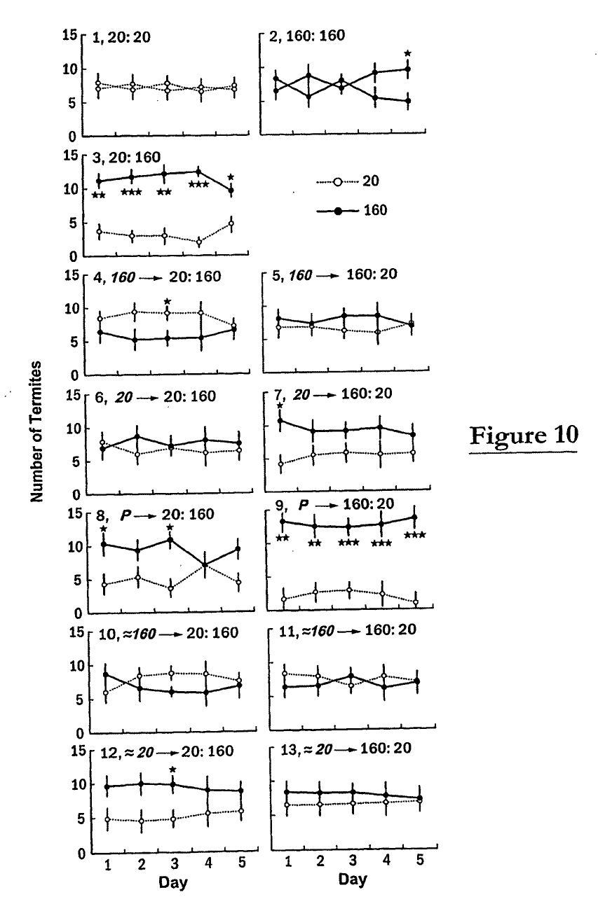

Food size preferences. First the food size preference of C. secundus termites was determined by offering them a choice of two blocks of pine wood of different lengths (20 and 160 cm long) and controls of equal length (both 20 cm or both 160 cm) for two weeks (treatments 1 to 3 in FIG. 7). The termites were able to crawl on only one surface of each block, which were almost identical, and were prevented from crawling along the lengths of the blocks. FIG. 10 illustrates the daily position of the Cryptotermes secundus termites in the food size preference experiment. The average (±standard error) number of workers sitting on either block for each treatment during the first five days of observation is shown. Each plot corresponds to a single treatment, with the respective treatment number and block lengths shown above each plot. Also indicated is the playback signal applied, if any, by the same symbols used in FIG. 7.

In the plots of FIG. 10, the open circles with dotted line indicate the results for the 20 mm blocks, while the closed circles with solid line indicate the results for the 160 mm blocks. The significance of each daily result is indicated as follows: * indicates that p<0.05; ** indicates that p<0.01; and *** indicates that p<0.001. Non significance is not indicated.

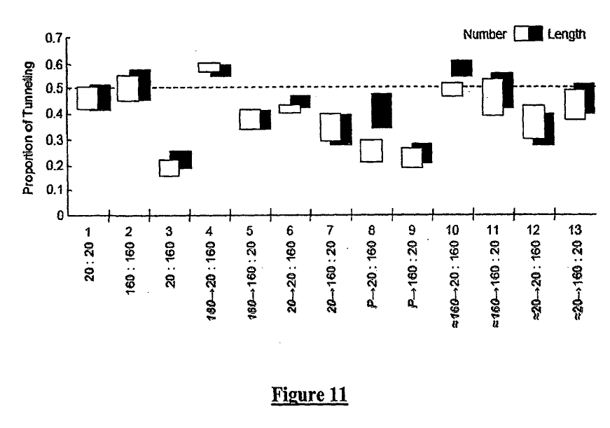

FIG. 11 illustrates the tunneling activity of C. secundus termites at the end of the food size preference experiment. Data are the proportion of total tunneling in the 20 mm blocks. Open bars represent the 95% confidence intervals of the number of tunnels; closed bars the 95% confidence intervals of the average total tunnel length. For treatments 1 (20:20) and 2 (160:160), one block in each pair was chosen randomly to calculate proportion of tunneling activity for comparison with other treatments. The dotted line indicates 50% (i.e., no preference); consequently if the bars do not overlap this line they differ significantly from equality. Treatment symbols are the same as in FIG. 10.

FIG. 10 reveals that the Cryptotermes secundus termites had no preference when presented with two equal sized pieces of wood: in treatment 1 similar numbers of termites were observed on the inner surfaces of the two 20 mm blocks; and in treatments 2 similar numbers of termites were observed on the inner surfaces of the two 160 mm blocks, during the first five days of observation. Further, FIG. 11 shows that after two weeks, the termites in treatments 1 and 2 had produced a similar number of holes in either block and these were of similar length (95% CI overlap 0.5).

In contrast, in treatment 3 the Cryptotermes secundus termites showed a clear preference for the 160 mm block of wood when it was paired with a 20 mm block. FIG. 10 shows that more workers were observed sitting on the 160 mm surface in the first five days. FIG. 11 shows that after two weeks, the termites in treatment 3 had produced significantly more holes and significantly deeper tunnels in the 160 mm block (95% CI well beneath 0.5).

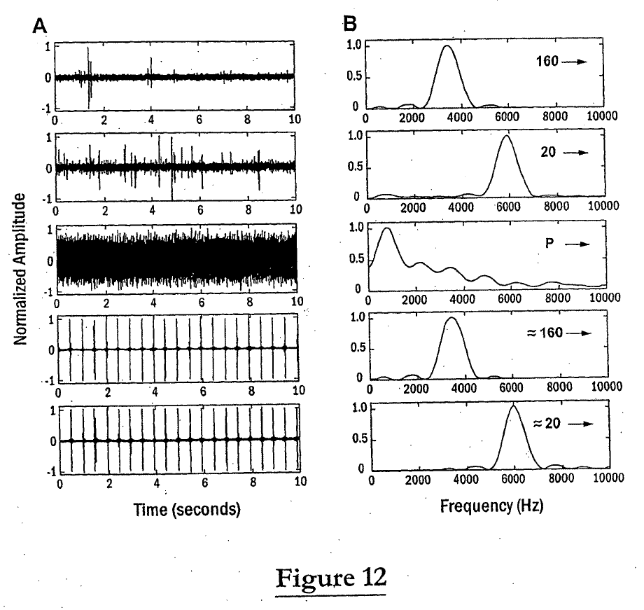

The mechanism for determining food size was also investigated. Recordings were made of the vibration signals produced by groups of 15 C. secundus workers consuming either 20 or 160 mm long pine wood. The upper two plots of FIG. 12A show the time series of the natural signals thus recorded, while the lower three plots of FIG. 12A illustrate time series of artificially generated vibration signals. The plots of FIG. 12B illustrate the corresponding fast Fourier transform of the natural and artificial vibration signals, showing the frequency spectra. These five different signal types were used in the experiments, and the symbols in the upper right corner of each graph of FIG. 12B identifying each signal type are used throughout FIGS. 7, 8, 10, 11, 13, 14 and 15, and Table 2A, to indicate the particular signal used in each playback experiment.

As can be seen in the upper two plots of FIG. 12B, the dominant frequency for the 160 mm block was 3.5 kHz, and the dominant frequency for the 20 mm block was 5.9 kHz. Therefore the dominant frequency recorded from termites eating the wood blocks varied inversely with block length, as seen for C. domesticus (refer to FIG. 2). Artificial signals having a dominant frequency of 3.5 kHz and 5.9 kHz, respectively, were synthesized to mimic the natural signals, as shown in the lower two plots in FIGS. 12A and 12B. These signals were also played to C. secundus workers in pairs of 20 mm and 160 mm pine wooden blocks (treatments 10 to 13 in FIG. 7), to determine whether their food preferences could be altered, in a similar manner as seen for C. domesticus. Each natural signal was also played into either the 20 mm or the 160 mm wooden block (treatments 4 to 7 in FIG. 7), and termite responses observed. A random noise (pink noise) signal was also played to control for presence of signal (treatments 8 and 9).

Treatment 4, in which the natural 160 mm signal was played into the 20 mm blocks, caused the wooden block preference to be reversed for termite movement (as shown in FIG. 10), and also reversed for number and length of tunnels (FIG. 11). Thus, treatment 4 revealed that C. secundus appeared to choose wooden blocks based on the vibration signal. The results for the corresponding artificial 160 mm signal in treatment 10 showed a change also; a loss of significant difference in termite movement (shown in FIG. 10) and number of tunnels (open bar in FIG. 11). For tunnel length, termites in treatment 10 showed a clear preference for the 20 mm blocks (closed bar in FIG. 11).

Random noise had minimal effect on termite decisions, as termite behaviour in the pink noise treatments (treatments 8 and 9) largely matched the behaviour observed without any recordings being played (i.e. in treatment 3, 20:160). For pink noise signal played into the 20 mm block (treatment 8) and pink noise signal played into the 160 mm block (treatment 9), termites were observed significantly more often on the larger block (FIG. 10) and they tunneled significantly deeper in the larger block (FIG. 11).

Natural signals were played into blocks of similar size: in treatment 5 the natural 160 mm signal was played into the 160 mm block, and in treatment 6 the natural 20 mm signal was played into the 20 mm block. As shown in FIG. 10, in these treatments there was no significant difference for termite movement compared to treatment 3. The tunneling data shown in FIG. 11 suggested a reduced preference for the 160 mm wooden blocks in these treatments compared with treatment 3, although the preference for the 160 mm block was still significant.

In treatment 7, the 20 mm signal was played into the 160 mm wooden block. As shown in FIG. 10 the preference for the 160 mm block disappeared for termite movement, but a preference for the 160 mm block was still found for the tunneling data of FIG. 11. The corresponding artificial signal playback experiments of treatments 11, 12 and 13 did not give the same results as the natural signals. Thus, it does not appear that C. secundus was choosing wooden blocks only on the basis of the dominant frequencies in the signals. Therefore further experiments were carried out to assess the attractiveness of the signals to the C. secundus termites.

Attractiveness of signal. Results from the food size preference experiment suggested that C. secundus workers chose to tunnel into the wooden blocks using not only the information of the dominant signal frequency, which indicates the wood size. To test whether natural signals were attractive, individual termites were placed on cardboard T-mazes of the type shown in FIG. 8, one side of which received either the 160 mm natural signal, the pink noise signal, or no signal was played at all.

FIG. 13 illustrates the number of C. secundus termites that did not make a choice in the attraction experiment. Data are the average±standard error of workers that did not complete the T-maze within the time limit (120 s). Signal symbols and significance are indicated in the same manner as in FIG. 10. As can be seen, the termites were significantly more likely to make a decision when a signal was played. There was a significant difference in the number of termites that did not make a choice within the two minute test period between treatments (F_{2,15}=8.177, p=0.004); significantly more termites did not make a choice in treatment 1 (no signal), than in the other treatments, treatment 2 (pink noise) and treatment 3 (natural 160 mm signal) (Bonferroni adjusted p<0.05).

Termites did not have a preference for left or right because a similar number of termites chose to turn left and right when no signal was played in treatment 1 of FIG. 8: a total of 61 termites turned left and 59 turned right. This was not significantly different (average number of termites per colony turning: left=10.2±0.5, right=9.8±0.5; χ²₁=0.033, p=0.855).

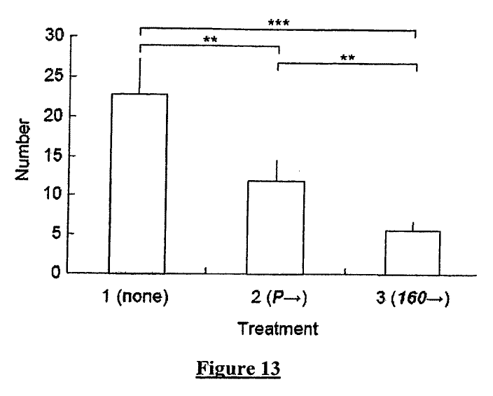

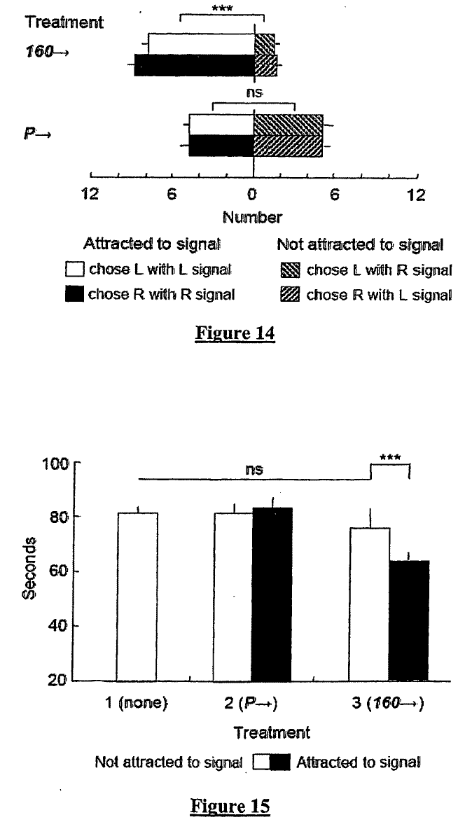

Termites were not attracted to random noise, because when they were played the pink noise signal in treatment 2 of FIG. 8 a similar number of termites chose to walk to the signal or away from it: a total of 58 termites walked to the signal and 62 walked away. This was not significantly different (average per colony, chose signal=9.7±1.8, chose no signal=10.3±1.8; χ²₁=0.133, p=0.715). FIG. 14 illustrates the number of C. secundus termites that did make a decision in the attraction experiment. Data are the average±standard error of workers that did complete the T-maze within the time limit (120 s). Note values are halved as data are divided into left and right. Signal symbols and significance are indicated in the same manner as in FIG. 10. FIG. 14 reveals that the lack of attraction to the pink noise of treatment 2 of FIG. 8 was regardless of whether the signal was played on the left or the right.

In contrast, treatment 3 of FIG. 8 reveals that termites were attracted to the recordings of other termites. When termites were played the natural 160 mm signal in treatment 3, about five times more termites chose to walk to the signal than away from it: a total of 101 termites compared with 19, illustrated in FIG. 14. A majority of termites in all six colonies chose to walk to the signal also, which was significantly different (average per colony, chose signal=16.8±0.8, chose no signal=3.2±0.8; χ²₁=55.962, p<0.001).

FIG. 15 illustrates the time taken by C. secundus termites to make a decision in the attraction experiment. Data are the average±standard error of time taken to walk the T-maze. Signal symbols and significance are indicated in the same manner as in FIG. 10. FIG. 15 shows that termites that did not walk to a signal in treatments 1, 2 or 3 of FIG. 8 took similar amounts of time to make a decision (about 78 seconds), whether in treatment 1, 2 or 3 (F_{2,198}=0.440, p=0.645). For those termites that walked to a signal, they walked significantly faster when they were played the natural 160 mm signal than those played the pink noise signal (F_{1,157}=17.647, p<0.001). Furthermore, termites that walked to the pink noise signal did not walk faster than those that walked away from the pink noise signal (t₁₁₈=0.458, p=0.647).

Table 2A shows the time taken by Crypt. secundus termites to make a decision in the attraction experiment. The walking time has been divided into quartiles and the number of individual termites that chose within those quartiles was counted. Note that in the pink noise signal treatment there was a similar spread of data for ‘away’ and ‘towards’ results, with only one fifth of the termites in the first and second quartiles, whereas in the 160 mm natural signal treatment about one half of the termites were in these two shortest quartiles.

TABLE 2A

| | | |
|---|---|---|
| Walking time | Pink noise signal | 160 mm natural signal |

| quartiles | away | towards | away | towards |
|---|---|---|---|---|
| <20 | 0 | 3 | 2 | 16 |
| 20-40 | 17 | 11 | 4 | 30 |
| 40-60 | 21 | 18 | 6 | 37 |
| 60-80 | 24 | 26 | 7 | 18 |

Away = termites chose side without signal.
Towards = termites chose side with signal.

### Example 2

### Discussion

Results from treatment 3 in the food size preferences experiment reveal that Cryptotermes secundus workers could detect food size, as they chose to tunnel into the 160 mm block. Yet food size did not appear to be the only influence on block choice when results from the playback treatments were considered. There were four paired playback treatments comparing natural signals with artificial signals: treatments 4 and 10, treatments 5 and 11, treatments 6 and 12, and treatments 7 and 13. If block choice was influenced only by the dominant frequency in the signals that indicated block size, then the results of these paired treatments ought to have been the same, yet they were not. This suggested that the termites were detecting information other than dominant frequency, from the more complex natural signals. A further effect was shown by the attractiveness of signal experiment, which demonstrated that worker termites were attracted to natural signals but not artificial pink noise signals.

The results of the food size experiment shown in FIG. 10 have been appraised as to the effect of food size, on one hand, and the effect of attractiveness of vibrations emanating from other conspecific termites, on the other hand. The former is illustrated by the results for treatment 3 in the food size preference experiment, which show that the larger 160 mm block is preferred. The latter is illustrated, for example, by considering treatment 4 in the food size preference experiment in which the natural 160 mm signal was played into a 20 mm block paired with a 160 mm block without a signal. In this treatment the termites should perceive both blocks to be similar in size, due to the dominant frequency of 3.5 kHz in the signal, but should prefer the 20 mm block because from it emanates the natural signal that indicates the presence of other termites.

Table 2B indicates the expected foraging choices of wooden blocks by Cryptotermes secundus when applying or ‘summing’ these two effects, compared to the observed foraging choices. The numbers in Table 2B indicate the size of the wooden block either expected to be chosen by the termites (expected choice), or actually chosen (observed choice). Observed choice was measured by either more termites, more tunnels or longer tunnel length, data from FIGS. 12, 13 and 14. A dash indicates that either no choice was expected or observed, while the question mark indicated the ‘sum’ of the effects in treatment six was unknown. Signal symbols are indicated in the same manner as in FIG. 10.

TABLE 2B

| | | Expected choice | | | Observed choice | | |
|---|---|---|---|---|---|---|---|
| Treatments | | Food | Attrac- | | Termite | Tunnel | Tunnel |
| # | Symbol | size | tion | Sum | position | number | length |
| 1 | 20:20 | — | — | — | — | — | — |
| 2 | 160:160 | — | — | — | —^{a} | — | — |
| 3 | 20:160 | 160 | — | 160 | 160 | 160 | 160 |
| 4 | 160→20:160 | — | 20 | 20 | —¹ | 20 | 20 |
| 5 | 20:160→160 | 160 | 160 | 160 | — | 160 | 160 |
| 6 | 20→20:160 | 160 | 20 | ? | — | 160 | 160 |
| 7 | 20:20→160 | — | 160 | 160 | —^{a} | 160 | 160 |
| 8 | P→20:160 | 160 | — | 160 | 160^{b} | 160 | 160 |
| 9 | 20:P→160 | 160 | — | 160 | 160 | 160 | 160 |
| 10 | ≈160→20:160 | — | — | — | — | — | 20 |
| 11 | 20:≈160→160 | 160 | — | 160 | — | — | — |
| 12 | ≈20→20:160 | 160 | — | 160 | —^{a} | 160 | 160 |
| 13 | 20:≈20→160 | — | — | — | — | 160 | — |

^{a}observed choice indicated as a dash because only 1 of 5 days was significantly different.
^{b}observed choice indicated as a block because 2 of 5 days were significantly different

As can be seen in Table 2B, of twelve treatments in which a clear expected choice could be determined, the expected choice matches the observed result in eleven treatments. The single exception was treatment 11, in which the artificial 160 mm signal was played into the 160 mm block, in which the expected choice was the 160 mm block, but in which the termites did not make a clear choice. Treatment 6 was the only treatment in which an expected choice could not be determined, because the two effects predicted opposite choices, and it is unknown which effect might prevail.

### Example 3

### Coptotermes Acinaciformis

Examples 1 and 2 both related to members of the Cryptotermes genus, which is a drywood termite genus. Drywood termites are incapable of tunneling through soil, and therefore are confined to a single tree in a natural forest setting (except for alates that fly to establish new colonies). Subterranean termites are capable of tunneling through soil (hence their common moniker), and therefore can find and use a large number of food resources (e.g. trees, logs, wood in service). Drywood termite species tend to have relatively small queens and small colonies, due to their smaller quantity of food, compared with subterranean termites. Given these differences, it was decided to investigate the possible attractive effect of vibration feeding signals in a subterranean termite species. The widespread and economically important species Coptotermes acinaciformis was chosen, with testing performed through use of signals recorded from a similar species Coptotermes lacteus.

### Example 3

### Methods

Measuring signals. Recordings were made of the vibration signals produced by groups of Coptotermes lacteus workers on blocks of Pinus radiata wood 20, 80, 160, 320 mm long, respectively. A small plastic enclosure (sealed with a water soaked sponge) was attached to the top of the wooden blocks. This was necessary because these termites require a water supply. About 250 workers and soldier Copt. lacteus were placed inside the plastic boxes. A Brüel & Kjaer (B&K) 4370 accelerometer (charge sensitivity 10.121 pC/ms⁻²) was attached to the base of the wooden block under test, and this was connected to a Brüel & Kjaer 2635 charge amplifier. The experiment was performed in an anechoic room, and the signal was monitored using an Ono Sokki Fast Fourier Transform (FFT) analyser CF 350 and recorded on a PC for analysis using MATLAB signal processing toolbox.

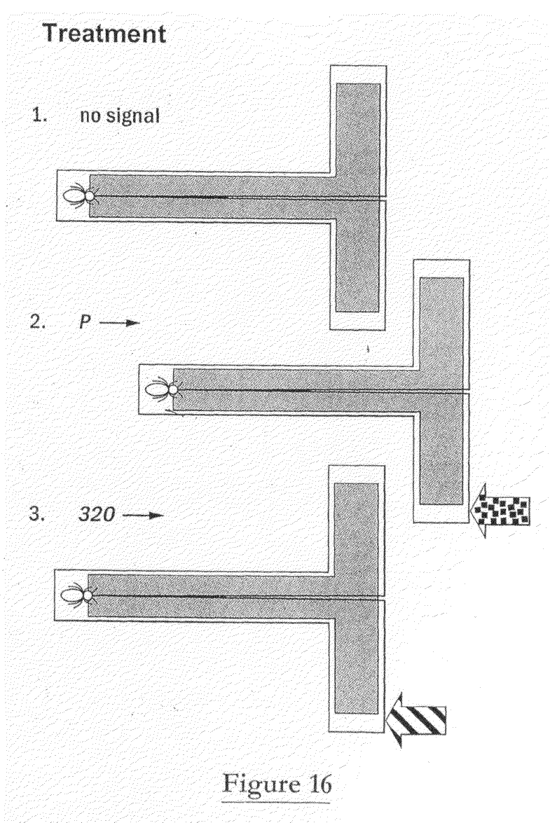

Attractiveness of signal. The potential attractiveness of signals was examined to determine whether the natural vibration signals did indeed have an attractive effect. FIG. 16 is a schematic of the attractiveness of signal experimental treatments. Cardboard T-mazes were cut as shown. The termite represents a single worker termite of Coptotermes acinaciformis placed at the proximal end of the T-maze, while the shaded arrows represent a signal played at one of the two distal ends of the T-maze. The light grey shaded T shape indicates the transparent plastic T shaped cover over the maze. The symbol P→ indicates that pink noise is played at the distal end of the second T-maze, while the symbol 320→ indicates that playback of the natural frequency recorded from feeding Coptotermes lacteus on 320 mm wooden blocks signal occurs at the distal end of the third T-maze.

The cardboard T-mazes of FIG. 16 were 120 mm long and 120 mm wide; the breadth of the cardboard was 20 mm. The two distal ends were gripped by bulldog clips that were attached to Philip Harris shakers, which were plugged into Sony Discmans. The T-maze was cut along the mid line, from the distal end to 15 mm short of the proximal end, and the two distal ends were pulled about 0.5 mm apart, to reduce signal transmission from one side of the T-maze to the other.

A single termite Coptotermes acinaciformis was placed at the proximal end of the T-maze and a transparent plastic T shaped cover (about 5 mm smaller in all dimensions than the cardboard T) was placed on the T. This cover reduced the air movement disliked by termites, and helped prevent the termite from walking under the T-maze. A termite was determined to have made a choice when it had walked up the T, turned left or right and walked 40 mm towards a bulldog clip, in not less than eight seconds, and no more than 80 seconds. The lower time limit was chosen because this was the minimum time a Coptotermes acinaciformis worker can walk and investigate the T-maze and so make a choice based on all available stimuli. A shorter time indicates a flight response, in which the Coptotermes acinaciformis worker runs the T-maze in a straight line without investigating any stimuli of the T-maze (in fact, such is their haste, workers often fall off the end of the T-maze as they cannot stop). The upper time limit was chosen as it was ten times the lower limit; if a termite had not made a choice in this time, it was discarded and a new test begun. Tests were run until 20 termites in three colonies had chosen for each treatment. No T-maze was used twice, to avoid confounding effects of any potential trail-following pheromone. The number of discards, the number of each signal choice, and the time taken to choose were tested using ANOVA and paired t-tests.

### Example 3

### Results

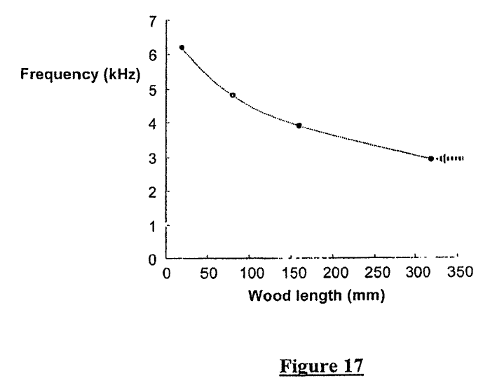

Measuring signals. FIG. 17 illustrates the dominant resonant frequency of P. radiata wooden blocks excited by Copt. lacteus termite workers. The arrow indicates the 320 mm natural signal used as playback in the attractiveness of signal experiment. FIG. 17 shows that the dominant frequency recorded from the wooden blocks varies inversely with block length, so that the dominant frequency decreases as block size increases, in a similar fashion as observed for Cryptotermes domesticus and Crypt. secundus.

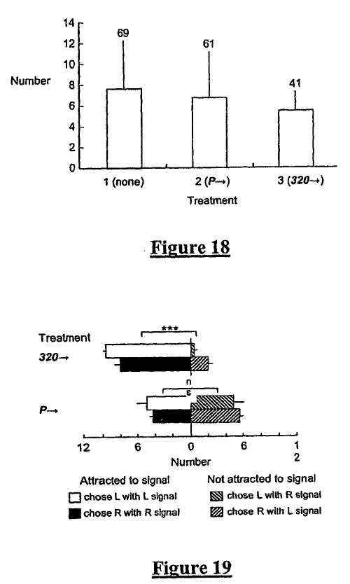

Attractiveness of signal. FIG. 18 illustrates the number of Copt. acinaciformis termites that did not make a choice in the attraction experiment. Data are the average±standard error of workers that did not complete the T-maze within the time limit (8-80 s). Signal symbols and significance are indicated in the same manner as in FIG. 16; the total number is written above each column. As can be seen, the termites were more likely to make a decision when a signal was played, although these differences were not significant (F_{2,6}=0.513, p=0.623; probably due to the large variation for the number of colonies tested).

Termites did not have a preference for left or right because the same number of termites chose to turn left and right when no signal was played in treatment 1 of FIG. 16: a total of 30 termites turned left and 30 turned right. This was not significantly different (average number of termites per colony turning: left=10.0±0.0, right=10.0±0.0; χ²₁=0.000, p=1.000).

Termites were not attracted to random noise, because a similar number of termites chose to walk to the signal or away from the pink noise signal in treatment 2 of FIG. 16: a total of 28 termites walked to the signal and 32 walked away. This was not significantly different (average per colony, chose signal=10.3±0.7, chose no signal=9.7±0.7; χ²₂=0.076, p=0.782). FIG. 19 illustrates the number of Copt. acinaciformis termites that did make a decision in the attraction experiment. Data are the average±standard error of workers that did complete the T-maze within the time limit (8-80 s). Note values are halved as data are divided into left and right. Signal symbols and significance are indicated in the same manner as in FIG. 16. FIG. 19 reveals that the lack of attraction to the pink noise of treatment 2 of FIG. 16 was regardless of whether the signal was played on the left or the right.

In contrast, treatment 3 of FIG. 16 reveals that termites were attracted to the recordings of other termites. When termites were played the natural 320 mm signal in treatment 3, about seven times more termites chose to walk to the signal than away from it: a total of 53 termites compared with 7, illustrated in FIG. 19. A majority of termites in all three colonies chose to walk to the signal also, which was significantly different (average per colony, chose signal=17.7±0.7, chose no signal=2.3±0.7; χ²₁=13.78, p<0.001).

Table 3A shows the time taken by Copt. acinaciformis termites to make a decision in the attraction experiment. The data were not normally distributed, so a parametric analysis was not possible. Instead, the walking time was divided into quartiles and the number of individual termites that chose within those quartiles were counted. Note that in the pink noise signal treatment there was a similar spread of data for ‘away’ and ‘towards’ results, with around one third in the shortest time quartile, whereas in the 320 mm natural signal treatment half the ‘towards’ results were in the shortest time quartile.

TABLE 3A

| | | |
|---|---|---|
| Walking time | Pink noise signal | 320 mm natural signal |

| quartiles | away | towards | away | towards |
|---|---|---|---|---|
| <20 | 12 | 9 | 1 | 22 |
| 20-40 | 10 | 12 | 2 | 11 |
| 40-60 | 5 | 8 | 3 | 8 |
| 60-80 | 2 | 2 | 0 | 2 |

Away = termites chose side without signal.
Towards = termites chose side with signal.

### Example 4

### Coptotermes Acinaciformis Repulsion

Termites communicate alarm with a vibro-acoustic signal, generated either by the soldier termites drumming their heads against the substrate or shaking bodies held firmly to the substrate, in a manner which produces a train of pulses of substrate vibrations, with a pulse repetition rate of tens of Hz. The worker termites of the species have several types of organs that sense vibrations at the base of the antennae and on the tibiae, and have the ability to sense and interpret the pulse train of vibro-acoustic alarm signals. A usual reaction to this is to retreat into their nest. Other soldier termites often respond to an alarm signal, by generating their own alarm signals by drumming their heads.

Given that the usual worker response to alarm signals is to retreat, it is investigated here whether it is possible to play back alarm signals to repel termites from an area. Further, given that there are differences in vibro-acoustic alarm signals between different species, it is investigated whether specificity of the signal is important. The economically important species Coptotermes acinaciformis was chosen for test, and two alarm signals were used: that from C. acinaciformis and also from its relative C. frenchi.

### Example 4

### Methods

Measuring alarm signals. Recordings were made of the vibro-acoustic alarm signals produced by Coptotermes acinaciformis and Coptotermes frenchi. About 50 workers and 50 soldiers were placed inside nine centimetre petri dishes, which were then mounted on a Brüel & Kjaer (B&K) 4370 accelerometer (charge sensitivity 10.121 pC/ms⁻²). The termites were agitated (with air flow, paint brush and dead meat ants, Iridomyrmex purpureus) to elicit an alarm signal. The signal was conditioned and amplified using a Brüel & Kjaer (B&K) 2635 charge amplifier and the signals were recorded on a PC for analysis using Matlab. The spectra were high-pass filtered above 750 Hz to reduce the low frequency noise.

Repulsion of alarm signal. Also tested was whether termites could be deterred from eating wood by exciting the wood with termite alarm signals, using bioassays. The basic experimental unit was a large petri dish (15.5 cm diameter×6.5 cm high), which was filled with moistened vermiculite to a depth of two centimetres. Approx. 3000 (or 9 g) worker and soldier Coptotermes acinaciformis (Froggatt) termites collected from Griffith, NSW, Australia (lat. 34°30′0″ S, long. 146°0′0″ E) were placed into the petri dishes. Test blocks of seasoned, air-dried Pinus radiata wood (19×19×30 mm) were dry weighed and screwed onto bolts. Bolts were either fastened onto the petri dish walls to serve as controls, or into shakers that received an alarm signal from a CD player.

There were three treatments each replicated eight times. Treatment 1, no choice—no signal, had a single test wooden block that did not receive a signal. Treatment 2, no choice—with signal, had a single test wooden block that received an alarm signal. Treatment 3, choice—no signal and with signal, had two test wooden blocks, one that did not receive a signal and the other that did.

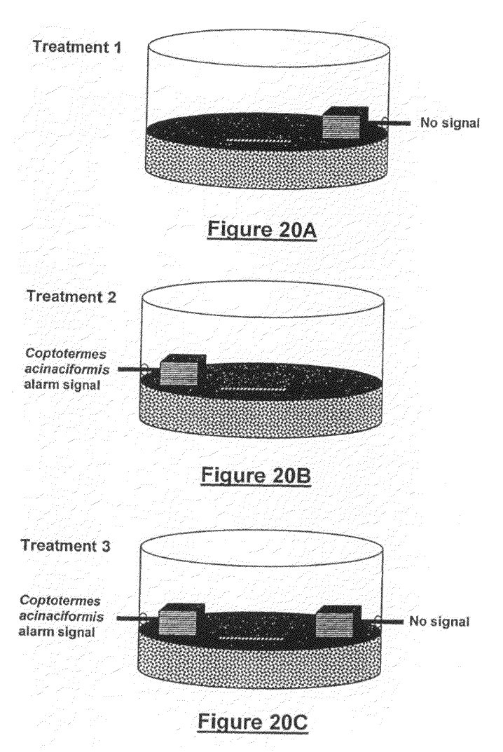

In the first experiment, the alarm signal recorded from C. acinaciformis (Froggatt) was played. A piece of Eucalyptus regnans veneer (50×30×2 mm) was also placed in the petri dish to provide additional food (FIG. 20). This combination was judged to be more similar to natural conditions. The experiment ran for six days.

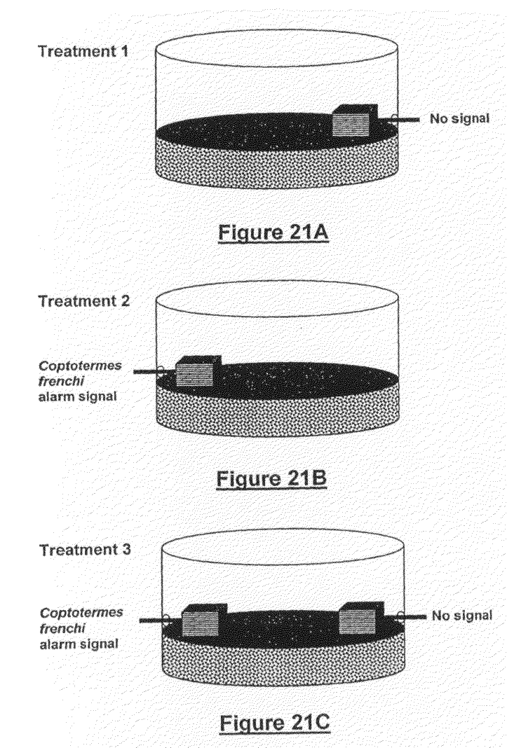

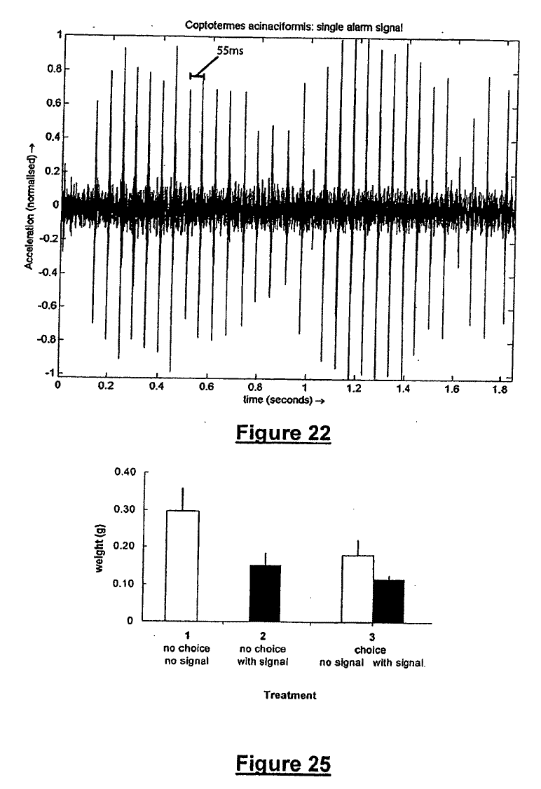

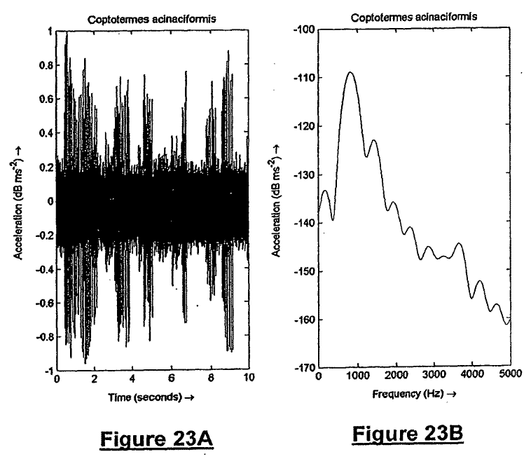

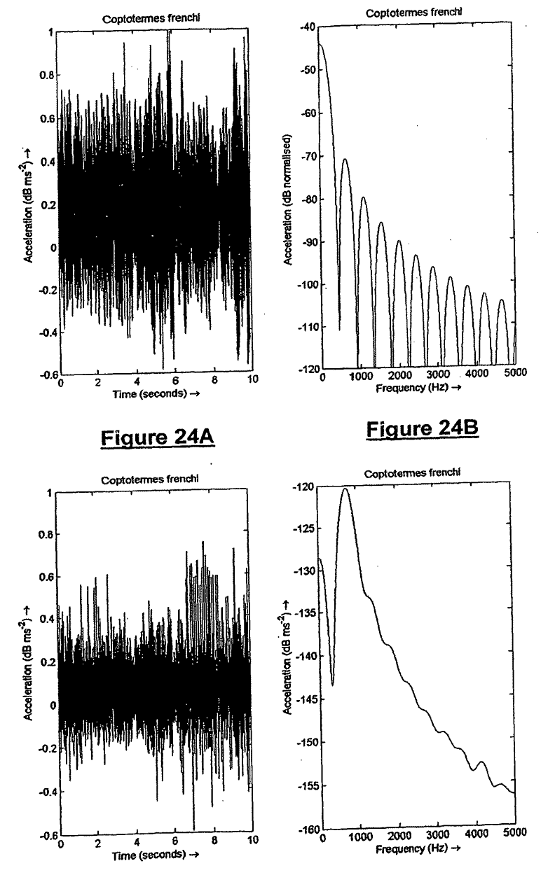

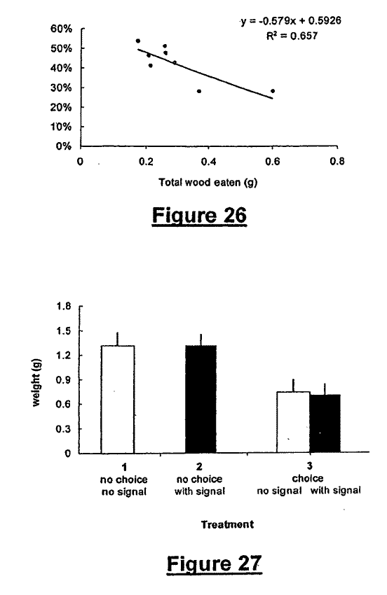

In the second experiment, the alarm signal recorded from C. frenchi (Hill) collected from Canberra, ACT, Australia (lat. 35°18′0″ S long. 149°8′0″ E) was played. There was no additional food in the petri dish (FIG. 21). This combination was judged to be a harsher test of the efficacy of the alarm signal. The experiment ran for seven days. Data obtained were the amount of wood consumed, which were log transformed to improve homogeneity of variance assumptions. Treatments 1 and 2 were compared with unpaired t-tests; choices within treatment 3 were compared with paired t-tests.

### Example 4

### Results

Measuring alarm signals. The alarm signals were characterised by relatively low frequency (8-20 Hz) impulses caused by the soldiers repeatedly hitting their heads on the substrate. FIG. 22 shows the time series of a single alarm signal event from an individual Coptotermes acinaciformis soldier (after being band-pass filtered between 969 Hz and 2605 Hz to reduce noise). As can be seen, the impulses are fairly regular, with an interval of approximately 55 milliseconds in this example.

Maxima in the long-time average of the response spectra were generally lower in amplitude in the case of Coptotermes acinaciformis (as shown in FIG. 23) than for Coptotermes frenchi (as shown in FIG. 24). Table 4A illustrates the distinction between the alarm signals of C. frenchi and C. acinaciformis, both in terms of differing pulse repetition frequency and in terms of distinct position of spectral peaks.

TABLE 4A

| | Pulse repetition | Frequency of peaks in |
|---|---|---|
| Species | frequency (Hz) | acceleration spectrum (Hz) |
| Coptotermes frenchi (Hill) | 15 | 763 |
| | | 1376 |
| | | 1833 |
| | | 2302 |
| | | 2746 |
| | | 3203 |
| | | 3648 |
| | | 4153 |
| Coptotermes acinaciformis | 18 | 819 |
| (Froggatt) | | 1417 |
| | | 1955 |
| | | 2374 |
| | | 2852 |
| | | 3630 |
| | | 4192 |
| | | 4635 |

Repulsion of alarm signal. In the first experiment shown in FIG. 20, using the alarm signal recorded from C. acinaciformis (Froggatt), clear differences in wood consumption between treatments were found. In treatment 1 shown in FIG. 20A (no choice, no signal), the termites had removed an average of about 0.3 grams of wood from the test block, whereas in treatment 2 shown in FIG. 20B (no choice, with signal) they had eaten about half this amount (FIG. 25). This difference was significant (t₁₄=2.549, p=0.023).

In treatment 3 shown in FIG. 20C, about 0.180 g of the no signal blocks were eaten, which was higher than the 0.115 g of the with signal blocks (FIG. 25). Although the trend for lower wood consumption in the signal blocks was evident, the difference was not significant (t₇=1.886, p=0.101). The lack of significance might be explained by the lower average consumption and high variability, or by the possible transmission of the alarm signal through the wall of the petri dish. Examining the proportion of the total amount of wood eaten represented by the alarm excited block (FIG. 26) suggests that the former explanation is more likely.

In the second experiment shown in FIG. 21, using the alarm signal recorded from C. frenchi (Hill), no differences were found. In treatments 1 (no choice, no signal) and 2 (no choice, with signal), the termites had removed an average of about 1.3 grams of wood from the test blocks, whereas in treatment 3 (choice, no signals and with signal) they had eaten about half this amount for each block (therefore a similar amount for both blocks added together), as shown in FIG. 27. These differences were not significant (treatment 1 cf. 2: t₁₄=0.019, p=0.985, treatment 3 no signal cf. with signal: t₇=0.657, p=0.532). FIG. 27 suggests that when no alternative food is available, C. acinaciformis termites ignore non-conspecific alarm signals.

### Example 5

### Comparison of Feeding Signals From Different Species

Although termites may all use and have similar vibro-acoustic signals, different congeneric species and different genera are likely to have variation between them. To quantify these possible differences, the economically important genera Coptotermes and Cryptotermes were compared, using a range of wooden block sizes. It is to be expected that frequency of the feeding vibro-acoustic signal is likely to depend not only upon wood size but also in part upon the wood species. To allow comparison of these factors a comparison of termite species and wood species is made here.

### Example 5

### Methods

Measuring feeding signals 1. Recordings were made of the vibro-acoustic feeding signals produced by groups of two species of Coptotermes (acinaciformis and lacteus) and five species of Cryptotermes (domesticus, dudleyi, primus, queenslandis, and secundus). For the Coptotermes species, a small plastic enclosure (sealed with a water soaked sponge) was attached to the top of the wooden blocks. This was necessary because these termites require a water supply. About 250 Copt. lacteus workers were placed inside the plastic boxes. For the Cryptotermes species, a 5-mm-deep hole was drilled into the top of each block, into which groups of 15 termites were placed.

The blocks of Pinus radiata wood ranged in size from 5 to 320 mm long (exact lengths changed slightly, but usually included 20, 40, 80, 160 and 320 mm). A Brüel & Kjaer (B&K) 4370 accelerometer (charge sensitivity 10.121 pC/ms⁻²) was attached to the base of the wooden block under test, and this was connected to a Brüel & Kjaer 2635 charge amplifier. The experiment was performed in an anechoic room, and the signal was monitored using an Ono Sokki Fast Fourier Transform (FFT) analyser CF 350 and recorded on a PC for analysis using the MATLAB signal processing toolbox.

Measuring feeding signals 2. Recordings were made of the vibro-acoustic feeding signals produced by groups of four species of subterranean termites: Coptotermes lacteus, Mastotermes darwiniensis, Nasutitermes exitiosus and Schedorhinotermes actuosus, all feeding on four species of wood: Ceratopetalum apetalum (Coach wood), Eucalyptus regnans (Mountain Ash), Populus euramerica (Poplar) and Pinus radiata (Monterey pine). The one coniferous species (Pinus radiata) contains some terpenes (pinenes), which are similar to the defensive chemicals produced by Nasititermes exitiosus. Therefore this termite species does not eat this wood species, so the experiment using a combination of these two species was not performed.

A plastic box (26×19×10 cm) containing a water soaked sponge was used to house termites and provide a water supply. About 1000 worker and soldier termites were placed inside the plastic boxes. A single block of wood of one size (80×50×20 mm) was used for recording feeding signals. The block of wood was drilled in one end (10 diameter, 10 mm deep) and a microphone was placed into the hole. Signals were amplified (Brüel & Kjaer 2635 charge amplifier) and recorded to computer. Analysis was on an Ono Sokki Fast Fourier Transform (FFT) analyser CF 350 and processed using MATLAB signal processing toolbox.

### Example 5

### Results

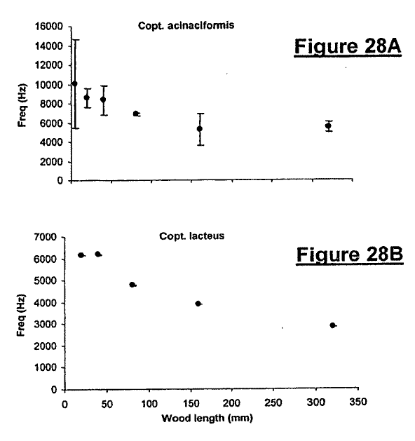

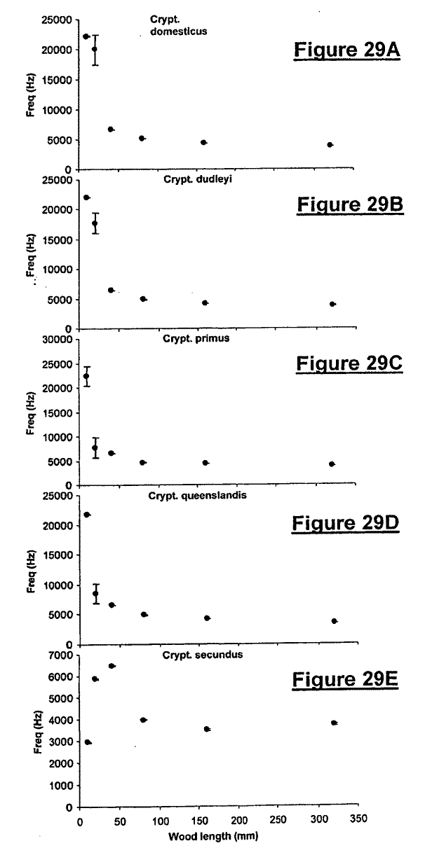

Feeding signal 1. Although the overall trend remained that the dominant frequency of the recorded signals decreased with increasing wooden block length, there were differences between species. The clearest difference was that for the shorter wooden blocks the Coptotermes species (Table 5A, FIG. 28) signals were of lower frequency relative to the signals of the Cryptotermes species (Table 5B, FIG. 29) for the same size blocks. Also, for the longer wooden blocks (especially 320 mm and 160 mm) the dominant frequency of the signals of Coptotermes acinaciformis was higher than for the signals of the Cryptotermes species on the same size blocks. By contrast for the longer wooden blocks (especially 320 mm and 160 mm) the dominant frequency of the signals of Coptotermes lacteus was lower than for the signals of the Cryptotermes species on the same size blocks. There were also differences between Cryptotermes species, but apparently there were not consistent patterns. Table 5A below gives results for the experiment upon Coptotermes.

TABLE 5A

| Species | Wood Length | Frequency | Std | No. |
|---|---|---|---|---|
| tested | (mm) | (Hz) | error | reps |
| Coptotermes | 5 | 10052 | 4608 | 5 |
| acinaciformis | 20 | 8591 | 1009 | 7 |
| (Darwin) | 40 | 8348 | 1527 | 6 |
| | 80 | 6897 | 148 | 6 |
| | 160 | 5266 | 1618 | 8 |
| | 320 | 5505 | 572 | 6 |
| Coptotermes | 20 | 6163.9 | 8.10 | 10 |
| lacteus | 40 | 6174.5 | 8.83 | 10 |
| (Canberra) | 80 | 4775.3 | 5.3 | 10 |
| | 160 | 3916.7 | 5.3 | 10 |
| | 320 | 2862 | 0 | 10 |

Table 5B below gives results for the experiment upon Cryptotermes:

TABLE 5B

| | Wood Length | Frequency | Std | No. |
|---|---|---|---|---|
| | (mm) | (Hz) | error | reps |
| Cryptotermes | 10 | 22160 | 55 | 3 |
| domesticus | 20 | 19931 | 2568 | 4 |
| (Darwin) | 40 | 6731 | 3 | 3 |
| | 80 | 5163 | 15 | 4 |
| | 160 | 4449 | 15 | 10 |
| | 320 | 3756 | 4 | 4 |
| Cryptotermes | 10 | 21948 | 8 | 8 |
| dudleyi (Torres | 20 | 17694 | 1742 | 9 |
| Strait) | 40 | 6368 | 4 | 7 |
| | 80 | 4888 | 23 | 7 |
| | 160 | 4195 | 3 | 7 |
| | 320 | 3807 | 58 | 4 |
| Cryptotermes | 10 | 22344 | 2068 | 8 |
| primus | 20 | 7717 | 2051 | 7 |
| (Queensland) | 40 | 6525 | 3 | 7 |
| | 80 | 4630 | 8 | 6 |
| | 160 | 4278 | 3 | 8 |
| | 320 | 3754 | 8 | 7 |
| Cryptotermes | 10 | 21695 | 19 | 7 |
| queenslandis | 20 | 8476 | 1672 | 8 |
| (Queensland) | 40 | 6500 | 9 | 8 |
| | 80 | 4862 | 33 | 7 |
| | 160 | 4174 | 4 | 8 |
| | 320 | 3414 | 2 | 7 |
| Cryptotermes | 10 | 21695 | 19 | 7 |
| secundus | 20 | 8476 | 1672 | 8 |
| (Darwin) | 40 | 6500 | 9 | 8 |
| | 80 | 4862 | 33 | 7 |
| | 160 | 4174 | 4 | 8 |
| | 320 | 3414 | 2 | 7 |

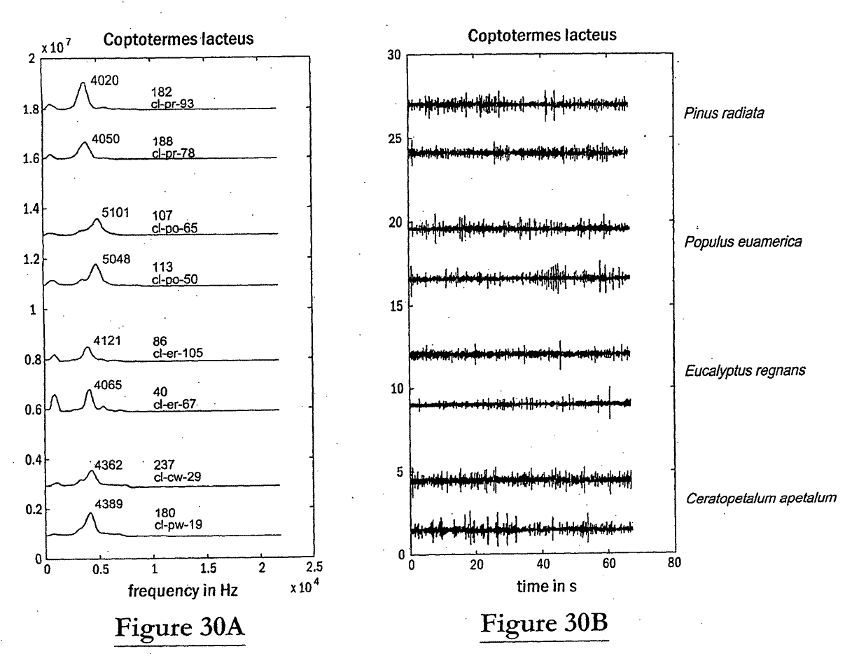

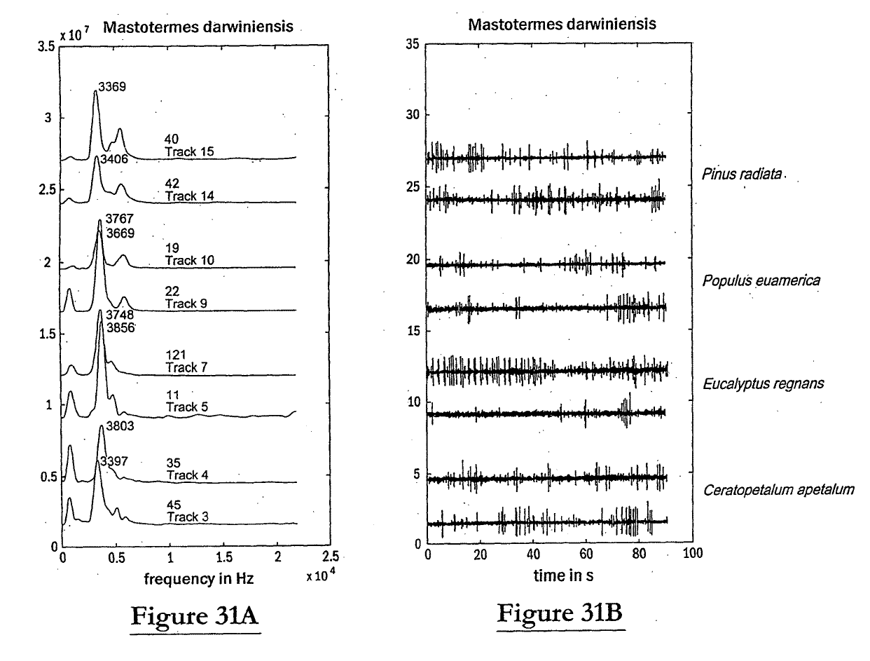

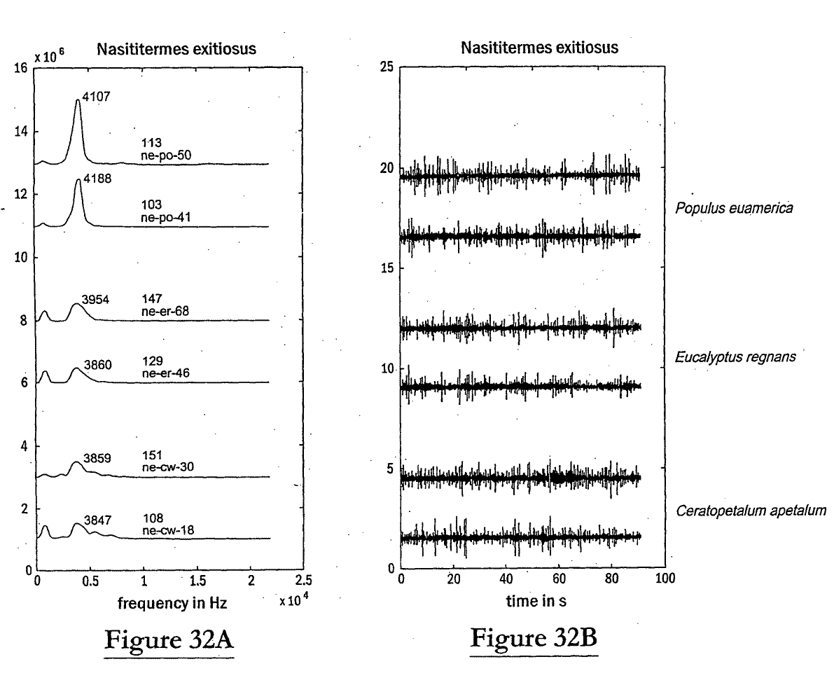

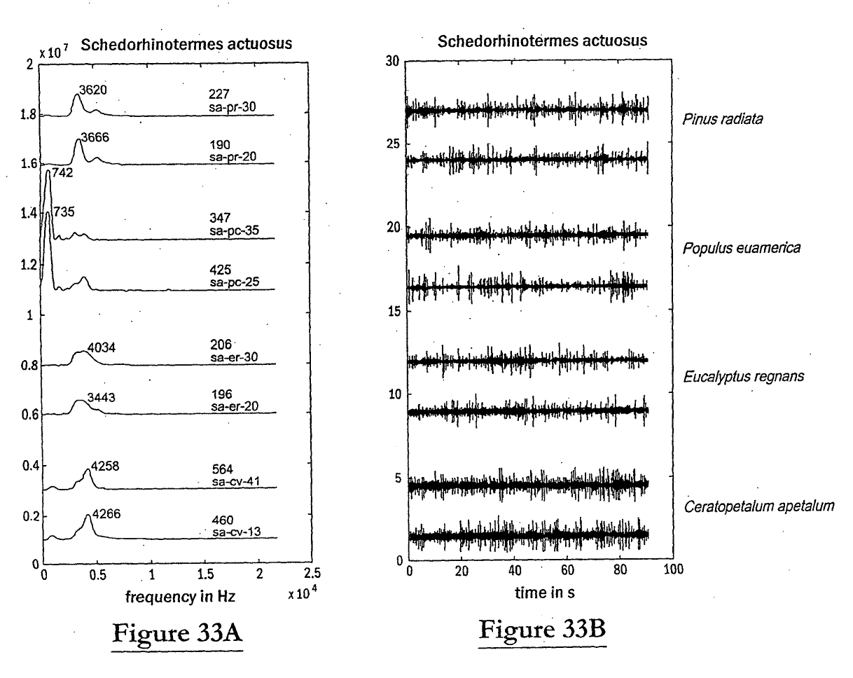

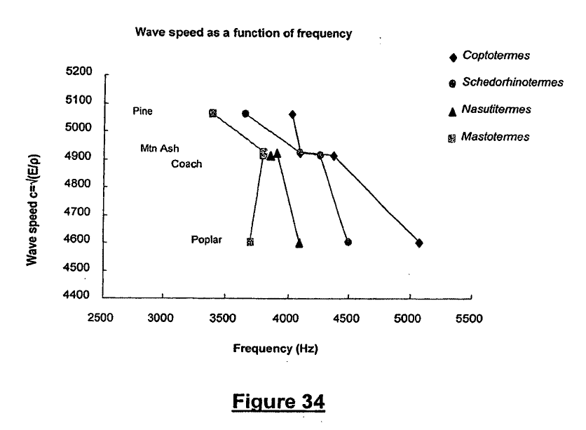

Feeding signal 2—multiple species comparisons. For the frequency analysis, the number of peaks used to compute the average frequency was quite high. There was some variability between recordings from the same termite species on the same wood species (see representative spectra in FIG. 30 for C. acinaciformis, FIG. 31 for M. darwiniensis, FIG. 32 for N. exitiosus and FIG. 33 for S. actuosus). When variability was low, the average values were used. When the variability was large, only the frequencies of the latest recording were used, because in later recordings the termites were settled and feeding was observed.

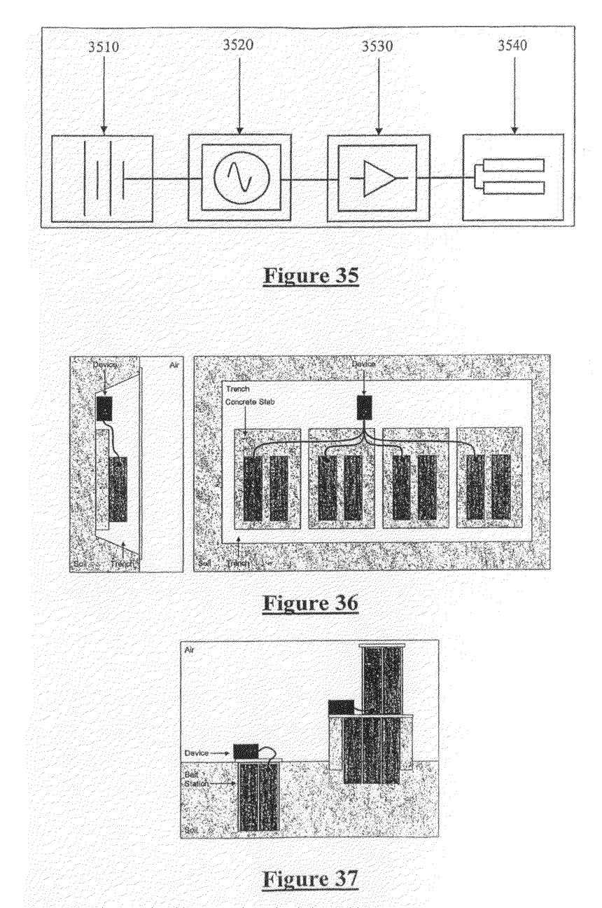

Notably, the dominant vibro-acoustic frequencies varied in a consistent pattern between termite and wood species. For a particular species of wood, the frequencies obtained for different species were different. Further, in order of frequency, each species of termites appeared in the same order on each species of wood: i.e. M. darwiniensis had the lowest frequency, then N. exitiosus, S. actuosus, and finally C. lacteus had the highest frequency (FIG. 34, Wave speed as a function of frequency).

The above examples 1 and 2 show that two species within the genus Cryptotermes behave differently. C. secundus preferred larger food and was attracted by conspecific signals, whereas C. domesticus preferred smaller food and appeared to be repelled by natural signals (C. domesticus reversed their preference for the smaller wood when natural signals were played, see FIGS. 4-6). Nevertheless, in both examples it has been shown that playback of vibrational signals allows influence to be exerted over termite behaviour. Further, in example 3 it has been shown that the widespread and commercially significant Coptotermes acinaciformis is attracted to vibrational signals of the Coptotermes lacteus species, and that playback of vibrational signals allows influence to be exerted over the termites' behaviour. The present invention exploits this recognition for the purposes of pest control. The present invention further recognises that playback of other types of influential vibrational signals may be applied for the purposes of pest control. It is to be appreciated that species-specific vibrational signals for playback may be obtained for other species in the same or similar manner described above in Examples 1-5, and that recordal and playback of such signals for alternative species is within the scope of the present invention.

FIG. 35 is a block diagram of a device for producing vibrational signals to influence the behaviour of termites in accordance with a first embodiment of the invention. The termite control device has four main conceptual components. The power supply 3510 is a dual power supply comprising a Li-ion rechargeable power supply. The device thus requires relatively little power, although the amplification stage will have to operate at high voltages. The actual power output may be determined to suit the application.

Signal generation is performed at 3520 by a portable flash-based MP3 player capable of reproducing WAV format with high fidelity. Additionally or alternatively a portable CD player (Sony D-EJ100) without amplification may be used for signal generation in a frequency range of 1-10 kHz.

High voltage amplification is required to drive the actuator 3540. This embodiment uses a high voltage amplifier 3530 with HV power supply having a maximum output voltage ±150V. Details of the amplification system in alternative embodiments will normally depend on the actuator type.

The actuator 3540 is a piezoceramic lead zirconate titanate (PZT) transducer in an annular shape having an outer diameter of approximately 15 mm, and an inner diameter of approximately 7 mm. The actuator 3540 is able to be coupled mechanically to a wooden substrate via the use of a self-tapping screw or to a concrete or metallic substrate by a bolt. In this embodiment the transducer is a PZT/bi-morph element (RS 285-784) embedded in a metallic washer system. In alternative embodiments the actuator type will generally be dependent on the output vibration amplitude required for the application in question.

The power supply 3510, signal generator 3520 and amplifier 3520 of FIG. 35 are contained within a container which is termite proof. Because termites can destroy plastics with a Shore D hardness of less than 80, the plastic components of the container are formed from unplasticised PVC. Similarly, a cable extending from the container to the actuator 3540 has a termite resistant sheath formed from nylon and/or woven stainless steel. The container is made waterproof as the device is likely to be located in high humidity locations, where a majority of termite pest problems arise, and may be located within trenches dug in the soil or on top of the soil, for example under houses in the crawl space.

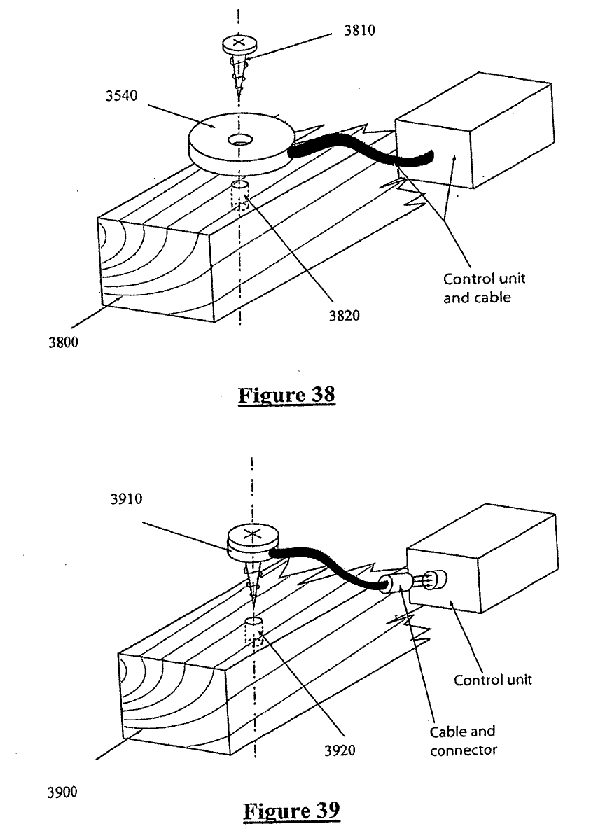

FIG. 36 is a schematic of a configuration for deployment of the device of FIG. 35, including a side view on the left of the Figure and a plan view on the right of the figure. As shown, the signal produced by the device may be distributed to more than one actuator for playback into respective wooden substrates. FIG. 37 illustrates two bait station deployments of the device of FIG. 35, one within the soil and one above the soil. In each arrangement an attractive signal is played into the sacrificial wood substrates which are provided together with an appropriate termite bait.

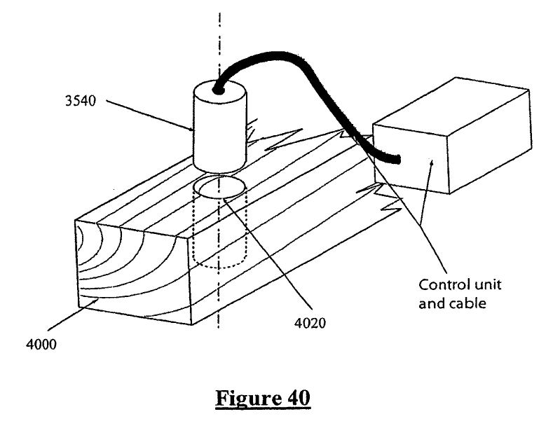

The device of FIG. 35 will, in use, be placed in different places and be coupled to different shaped and positioned wooden blocks, and the cable connection from the container to the actuator is of sufficient length to cater for such varied use. Moreover, to ensure that the vibrational signals are efficiently coupled from the actuator into the medium in question, a suitable coupling mounting should be effected. FIG. 38 illustrates a first configuration for coupling the actuator 3540 of the device of FIG. 35 to a wooden beam 3800. A pilot hole 3820 is drilled into the beam 3800 to accommodate a screw 3810. The screw 3810 passes through the eye of the annular actuator 3540 and secures it firmly to the beam 3800 so as to effect efficient coupling of the signal into the beam 3800.

FIG. 39 illustrates a second configuration for coupling the actuator of the device of FIG. 35 to a wooden beam substrate 3900. In this configuration the actuator is formed as a washer-type fitting to the screw 3910. The screw is accommodated in a pilot hole 3920 and secured firmly to the beam 3900 so as to effect efficient coupling of the actuator signal into the beam 3900.

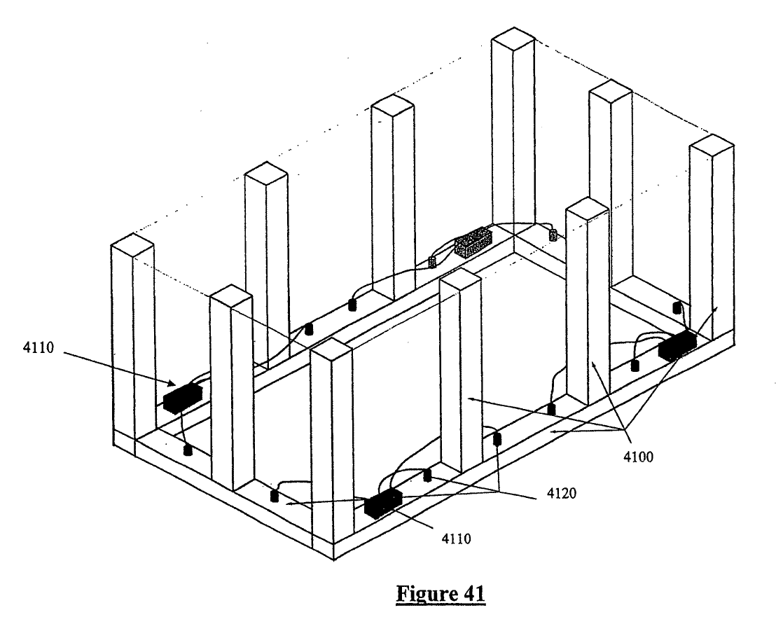

FIG. 40 illustrates a third configuration for coupling the actuator of the device of FIG. 35 to a wooden beam 4000. In this arrangement the actuator 3540 is formed in a rod shape and inserted in a friction fit into a guide hole 4020, and coupled to the beam 4000 by means of an adhesive such as e.g. epoxy, so as to effect efficient coupling of the actuator signal into the beam 4000. This may be applied directly on the surface of the substrate or member rather than being inserted into a cavity as shown.

FIG. 41 illustrates deployment of a plurality of devices 4110 of the type shown in FIG. 35 for the purpose of protecting a wooden building structure 4100, with each device 4110 having a plurality of transmitters 4120 distributed among the wooden members 4100 of a building structure.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1. A method of controlling pest termites, the method comprising:
generating a vibrational signal which is perceptible to and behaviourally influential upon the pest termites; and
coupling the vibrational signal into a medium for perception by the pest termites.

2. The method of claim 1 wherein the vibrational signal comprises a vibrational foraging signal.

3. The method of claim 1 wherein the vibrational signal comprises an alarm signal.

4. The method of claim 1 wherein the vibrational signal comprises an acoustic emission signal.

5. The method of claim 1 wherein the vibrational signal comprises an artificially synthesised signal.

6. The method of claim 1 wherein the vibrational signal is specific to a particular pest termite species.

7. The method of claim 1 wherein the vibrational signal is recorded from conspecific pest termites, and played back by the signal generator.

8. The method of claim 1 wherein the vibrational signal is a composition of multiple recordings from pest termites, played back simultaneously and/or sequentially.

9. The method of claim 1 wherein the vibrational signal is attractive to the pest termites.

10. The method of claim 9 wherein the attractive vibrational signal is used to lure termites into soil or wood treated with non-repellent insecticides.

11. The method of claim 9 wherein the attractive vibrational signal is used to lure termites away from a particular location.

12. The method of claim 1 wherein the vibrational signal is repellent to the pest termites.

13. The method of claim 1 wherein the vibrational signal is wirelessly communicated to a remotely located transducer.

14. The method of claim 13 wherein the vibrational signal is wirelessly communicated to a plurality of remotely located transducers.

15. The method of claim 1 wherein the vibrational signal is generated intermittently.

16. The method of claim 15 further comprising detecting termite acoustic emission, and commencing generation of the vibrational signal upon detection of termite acoustic emission.

17. A device for controlling pest termites, the device comprising:
a signal generator for generating a vibrational signal which is perceptible to and behaviourally influential upon the pest termites; and
a transducer for coupling the vibrational signal into a medium for perception by the pest termites.

18.-38. (canceled)

39. A method of controlling pest termites, the method comprising:
generating a vibrational foraging signal which attracts the pest termites;
coupling the vibrational foraging signal into a medium for perception by the pest termites; and
exposing termites attracted to the vibrational foraging signal to a termite controlling active substance.

40. A device for controlling pest termites, the device comprising:
a signal generator for generating a vibrational foraging signal which attracts the pest termites;
a transducer for coupling the vibrational foraging signal into a medium for perception by the pest termites; and
a termite controlling active substance to which termites attracted to the vibrational foraging signal are exposed.
